(19) United States
(12) Patent Application Publication
(10) Pub. No.: US 2002/0026385 A1
(43) Pub. Date: Feb. 28, 2002

(54) System and methods for generating an electronic purchase order for a part using a display of computer-aided design (CAD) drawing and related article and media

(76) Inventors: John M. McCloskey, Atlanta, GA (US); Budi Tan, Atlanta, GA (US); John Propper, Atlanta, GA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(21) Appl. No.: 09/871,758

(22) Filed: Jun. 1, 2001

Related U.S. Application Data
(60) Provisional application No. 60/229,505, filed on Aug. 31, 2000.

(51) Int. Cl. G06F 17/60

(52) U.S. Cl. 705/27

(57) ABSTRACT

A method of the invention can be used to select a part from a computer-aided design (CAD) display on a client device, and to generate an electronic purchase order with a server through interaction of the client device and server over a network. The CAD display can be generated by the client device with a browser that has a CAD display plug-in module to permit display of a CAD drawing. The CAD drawing can display part(s) associated with reference(s), and part data accessible to the server can be stored in association with such reference(s). Upon the user's selection of a part having a reference, the client device transmits this reference to the server via the network. The server receives the reference and uses it to access the part data for generation of the electronic purchase order. The part data can include part identification data and price data for the selected part. The part can be for an automobile, truck, boat, aircraft, or machine, for example. The server can store the electronic purchase order for later retrieval by part suppliers, shippers, carriers, or financial institutions for transfer of finds for the part purchase. The invention also extends to related methods, a system, a database storage unit, computer-readable and signal transmission media, as well as a data structure.

### CROSS-REFERENCE TO RELATED APPLICATION

This application claims priority benefits of U.S. provisional application No. 60/229,505 filed Aug. 31, 2000 naming John M. McCloskey, Budi Tan, and John Propper as inventors.

### FIELD OF THE INVENTION

1. Background of the Invention

The invention relates to a system and methods for purchasing a part for an automobile, truck, boat, aircraft, or machine, for example, using a computer-aided design (CAD) drawing displayed on a browser in a client/server network or distributed computing environment. The invention also is directed to a computer-readable article and transmission media to provide the capability to purchase a part in a client/server network or distributed computing environment.

2. Description of the Related Art

Whip!® viewer, release 3 and 4, are software packages available from Autodesk®, Inc., Cupertino, Calif. These software packages use the drawing web format (“dwf”) to allow computer-aided design (CAD) drawings in the “dwg” format to be displayed with a web browser. The “dwf” format compresses CAD drawings so that they can be transmitted electronically at a relatively fast rate. In addition “dwf” format permits hyperlinking so that a portion of a CAD drawing can be made ‘active’. A particular example given at the website of Autodesk®, Inc. assumes a mechanical engineer links the hub of a wheel to a spreadsheet containing the specific gravity, mass, and cost information. With a mouse, a user can click on the wheel and access the spreadsheet containing this information. The Autodesk®, Inc. website also indicates that “dwf” supports advanced hyperlinking, i.e., hyperlinking is not limited to data files, but can also activate Java applications, scripts, or other “dwf” files. Further information about the Whip® viewer is available from www3.autodesk.com.

AutoCAD® 2000i design software is commercially-available from the aforementioned Autodesk®, Inc. This design software provides the capability to develop CAD drawings in the “dwf” format. This design software also provides the capability to associate URLs as an attribute of a part displayed in a CAD drawing.

### SUMMARY OF THE INVENTION

A method of the invention can be used to select a part from a computer-aided design (CAD) display on a client device, and to generate an electronic purchase order for the part through interaction the client device and a server over a network. The CAD display can be generated by the client device with a browser that has a CAD display plug-in module to permit display of a CAD drawing. The method can include generating an electronic purchase order that has at least part identification data and price data for the selected part, based on a reference associated with the part in the CAD display. A user of the client device can initiate generation of an electronic purchase order for the part by activating the part shown within the CAD drawing using the client device. The method can facilitate transaction of a part purchase in a client/server network or distributed computing environment.

A system of the invention includes a client device, a server, and a database storage unit. The client device and server can be coupled to a network. The server can be coupled to the database storage unit. The client device can have a computer-aided design (CAD) display module plug-in to a browser running on the client device. The client device can generate a CAD display that has at least one part. The client device can be operated by the user to generate a signal indicating a user-selected part in the CAD display. The client device can transmit the signal indicating the user-selected part to the network. The server can be coupled to the network to receive the signal indicating the user-selected part from the client device. The server can retrieve part data from the database storage unit based on the signal indicating the user-selected part. The server can generate an electronic purchase order for the part based on the part data retrieved from the database storage unit.

A database storage unit of the invention stores at least one computer-aided design (CAD) data file for generating a display of a part that has a reference. The part data includes the reference listed in correspondence with part identification data and part price data. The reference can be a universal resource locator.

The invention extends to a computer-readable medium including a computer program for selecting a part from a computer-aided design (CAD) display on a client device, and transacting purchase of the part with the client device and a server over a network.

The invention is directed to a transmission medium for carrying a signal including a computer program for selecting a part from a computer-aided design (CAD) display on a client device, and for generating an electronic purchase order for the part using the client device through interaction with a server over a network.

A data structure of the invention comprises a computer-aided design (CAD) drawing depicting a part with at least one reference, and part data provided in association with the reference. The reference can include a universal resource locator (URL). The part data can include part identification data and part price data, for example.

Details of the construction and operation of the invention are more fully hereinafter described and claimed. In the detailed description, reference is made to the accompanying drawings, forming a part of this disclosure, in which like numerals refer to like parts throughout the several views.

### BRIEF DESCRIPTION OF THE DRAWINGS

FIGS. 1A and 1B are flowcharts of general methods of the invention;

FIGS. 2A-2I are flowcharts of a relatively specific method of the invention;

FIGS. 3A-3U are sequential views corresponding to the method of FIGS. 2A-2K showing graphical user interfaces generated by the client device interacting with the server and database storage unit;

FIGS. 4A-4C are views illustrating exemplary use of a reference associated with CAD data; and

FIGS. 5A and 5B are views of computer-readable medium and transmission medium, respectively, of the invention.

### DESCRIPTION OF THE PREFERRED EMBODIMENTS

### 1. Definitions

“Catalog” or “catalog menu data” refers to a hierarchical part menu of category(s) and possibly sub category(s) of part(s). The “catalog” can be defined by web page document(s) for respective category(s) and optional sub category(s).

“Category” refers to the highest level of a catalog. “Sub category” refers to any level below the highest catalog level.

“Client device” is a device that accesses resources of another device (i.e., server) via a network. The client device can be a personal computer, a network terminal, a personal digital assistant, or other device.

“Computer-aided design (CAD) drawing”, “CAD data file” or “display” refers to a computer-generated drawing used to display a part configuration and/or specification. CAD drawings are usually formatted in the “dwg” format.

“CAD display module” can be a software program such as the Whip!® viewer, release 3 and 4, are software packages available from Autodesk®, Inc., Cupertino, Calif. This module uses the drawing web format (“dwf”) to allow computer-aided design (CAD) drawings in the “dwg” format to be displayed with a web browser. The “dwf” format permits hyperlinking so that a portion of a CAD drawing can be made ‘active’. The CAD display module permits hyperlinking data files, Java applications, scripts, or other “dwf” files.

“Customer” or “purchaser” is the buyer of a part.

“Carrier” refers to an overnight mail carriers, postal service, truck, ship, rail or other carriers for transporting a part from one location to another. “Computer-readable medium” includes a compact-disk read-only memory (CD-ROM), digital versatile disk (DVD), magnetic media such as a floppy-disk or hard-disk, tape or other data storage media.

“Coupled” refers to joining a client device(s), server(s), or database storage unit(s) so as to permit signals to propagate therebetween. Such signals can be in electronic form and transmitted between coupled elements by a conductive line such as a wire or cable or other waveguide, or via wireless transmission of signals through air or other media, for example. Alternatively, such signals can be in optical form and transmitted via optical fiber or other waveguide, or by transmission of signals through air or other media, for example.

“Database storage unit” refers to a memory storage with random-access memory, hard-disk drive, tape or other storage medium type for the storage of data.

“Document” or “web page” refers to a document in hypertext mark-up language (HTML), extensible mark-up language (XML), or other language that includes a computer-readable code that can be used to generate a display with a web browser.

“File” refers to a set or collection of data.

“Graphical user interface” or “GUI” refers to the display and input unit of a client device that a user operates to interact with the client device.

“Input device” refers to a keyboard, mouse, wand or any other device that can be operated by a user to input commands or data into a client device.

“Log in” and “log out” refer to beginning and ending steps of a session of interaction between a client device and a server. Generally, “log in” entails entering user name and password at a client device and submitting these to a server. The server and/or database storage unit can be used to store user data associated with the user name and password.

“Network” can be local area network (LAN), wide area network (WAN), metropolitan area network (MAN), “the Internet”, a virtual private network (VPN) or other network, for example. The “network” establishes communication between applications running on client device and server(s). Such communication can be in accordance with the ISO/OSI model, for example.

“Part” can be a part of an automobile, boat, aircraft, machine, or other kind of part.

“Operation mode” refers to a mode in which a client/server system is being used to carry out purchase of a part with a CAD display of a client device in a client/server environment.

“Preparatory mode” refers to preparing a client/server system for carrying out purchase of a part in a transaction by selection of that part from a CAD display on a client device.

“Pre-stored” means stored in a database storage unit or other memory device before the operational mode.

“Reference” refers to a URL or other reference linking a part in a CAD drawing to another CAD drawing or part data pertaining to a part depicted in that CAD drawing.

“Server” refers to a processing device that is responsive to commands from a client device. The server can be a computer or computer-like device, for example. A “web server” or “network server” is a particular kind of server adapted to handle transmission of document data between one or more client device(s) and an internetwork such as the world wide web or Internet.

“Shipper” refers to an entity that packages and/or labels a part for shipment.

“(s)” at the end of a word means “one or more.” For example, “part(s)” means “one or more parts.”

“Transmission media” includes an optical fiber, wire, cable, or other media for transmitting data in optical or electric form.

“Universal Resource Locator” or “URL” is the address of a device such as a client or server accessible via internetwork.

“User” generally means refers to a human operator of a client device or other machine. The “user” may be a customer that purchases a part, or an agent of the customer authorized to purchase parts for the customer.

“Web browser” or “browser” is an application program that has the capability to parse and display an HTML document, and that interacts with one or more servers. For example, the web browser can be Internet Explorer® version 5 program available from Microsoft® Corporation, Redmond, Washington, or Communicator® version 4.5 program available from Netscape, Inc. “Web browser” also encompasses within its meaning HTML viewers such as those used for personal digital assistants (PDAs).

### 2. General Methods

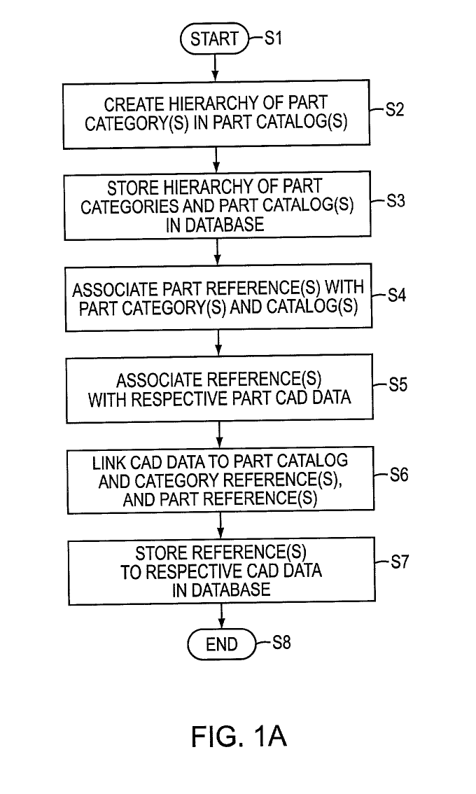

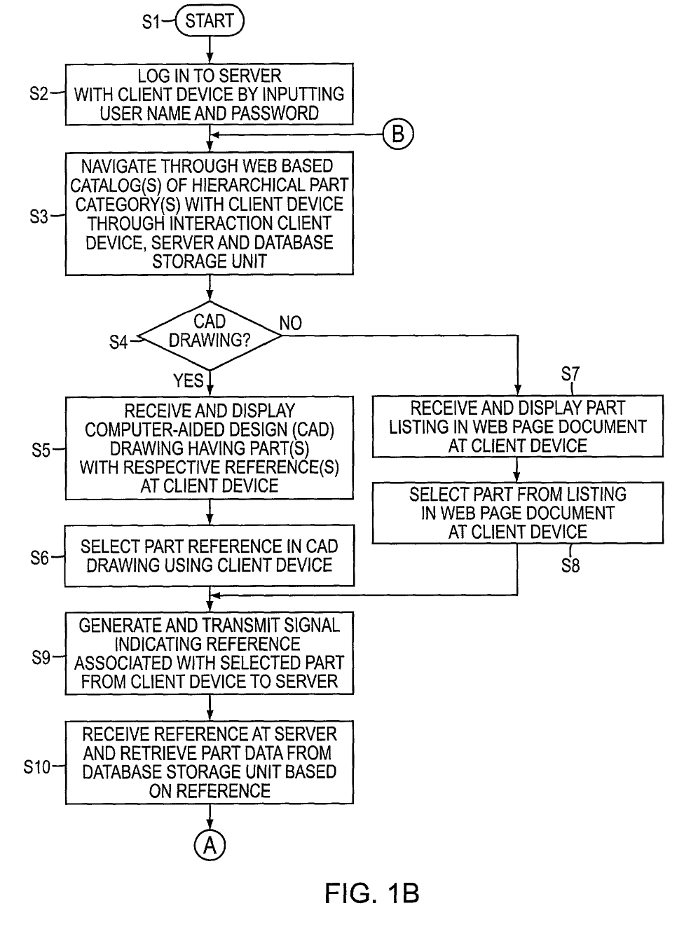

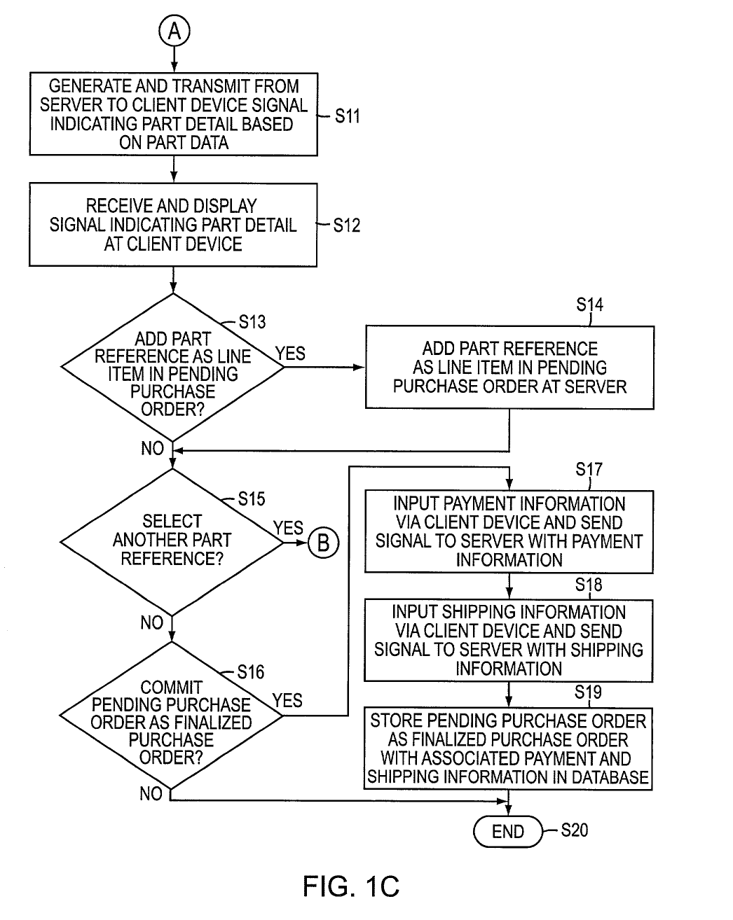

FIG. 1A is a generalized flowchart of a method for preparing a database stored in a database storage unit. The method of FIG. 1A can be used to prepare the database storage unit for use in a client/server or distributed computing environment to enable a user to select a part from a computer-aided design (CAD) drawing, to transact purchase of the part. The method can be performed by a programmer and/or server coupled to the database storage unit. In step S1 of FIG. 1A the method begins. In step S2 web page documents and bit-mapped images defining part categories are linked together. For example, the part categories can be bit-mapped images in an HTML document that is hyperlinked to another HTML document to define a hierarchical catalog menu from which a user can select a part starting at a general level to a level of greater specificity. For example, the catalog menu can be divided into different web page or HTML documents indicating a category (e.g., pumps), a sub category (e.g., mechanical pump), a sub category (e.g., mechanical pump rotor shaft), and a part within the sub category (e.g., a bearing of the mechanical pump rotor shaft). The user of the catalog can therefore navigate through the use of hyperlinked documents from a general level to the particular part of interest to the user. In step S3 the part catalog and part category references are stored in a database. In step S4 catalog and category references are associated with part references. In step S5 part references are associated with respective part(s) of a CAD data file(s). In step S6 CAD data file(s) are linked to category and part references. This provides the capability to activate a part in a CAD drawing display and to retrieve part data pertaining to that part from the database with the single action of activating the part using an input unit of the client device. In step S7 the CAD data file(s) are stored in the database. In step S8 the method of FIG. 1A ends.

The steps of FIG. 1A can be considered a preparatory mode of operation, in contrast to the operation mode carried out by a user in a client/server or distributed computing environment to transact purchase of a part through activation of the part displayed on a CAD drawing on a client device. This method is now described with reference to FIG. 1B.

The method of FIG. 1B begins in step S1. In step S2 the user “logs in” to the server with the client device by inputting the user name and password and submitting these to the server. If the user name and password are correct, in step S3 the user navigates through the hierarchical part categories of hyperlinked web pages with a client device through interaction of the client device, server, and database storage unit. In step S4 a determination is made with the client device to establish whether the result of the navigating step points to a CAD drawing having part(s) with respective reference(s). If the determination in step S4 is affirmative, in step S5 the client device receives the CAD drawing from the server and displays the CAD drawing having part(s) with respective reference(s). In step S6 the user operates the client device to select a part having a reference from the CAD drawing. On the other hand, if the determination in the step S4 is negative, in step S7 the client device receives and displays a part catalog listing in a signal transmitted from the server to the client device. The client device displays the part catalog listing. In step S8 the user selects a part from the part catalog listing on the client device. After performance of either step S6 or S8, in step S9 the client device generates and transmits reference associated with selected part in signal transmitted from client device to server via network. In step S10 the server receives the signal indicating the reference from the client device via the network, and uses the reference to retrieve part data for the reference from the database storage unit. In step S11 of FIG. 1C the server generates and transmits a signal indicating details of the selected part based on the part data retrieved from the database storage unit. In step S12 the client device receives and displays the part detail. In step S13 a determination is made whether to add the part reference as a line item to a pending purchase order. If the determination of step S13 is affirmative in step S14 the server interacts with the user via the client device to add the part reference to a pending purchase order. On the other hand, if the determination in step S13 is negative, in step S15 a determination is made whether to select another part reference. If the determination of step S15 is affirmative processing returns to step S3 and subsequent steps. On the other hand, if the determination in step S15 is negative, in step S16 a determination is made whether to commit the pending purchase order to a finalized purchase order. If the determination of step S16 is affirmative in step S17 the server interacts with the user via the client device to capture payment information for the finalized purchase order. In step S18 the server interacts with the user via the client device to capture shipping information for the finalized purchase order. In step S19 the server stores the finalized purchase order along with associated payment and shipping information in the database. After performance of step S19 or if the determination in step S16 is negative, the method of FIGS. 1B and 1C terminates in step S20.

### 3. Detailed Method

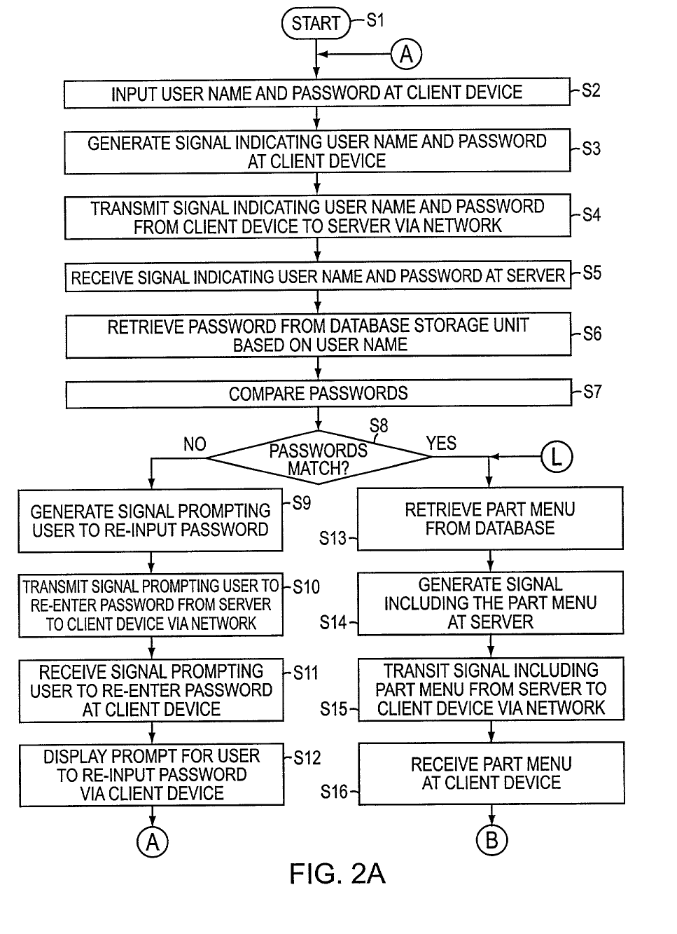

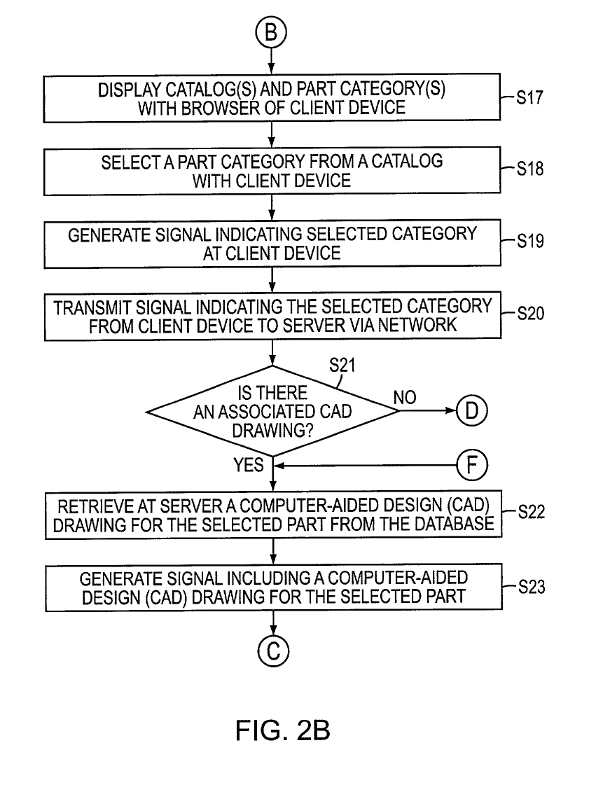

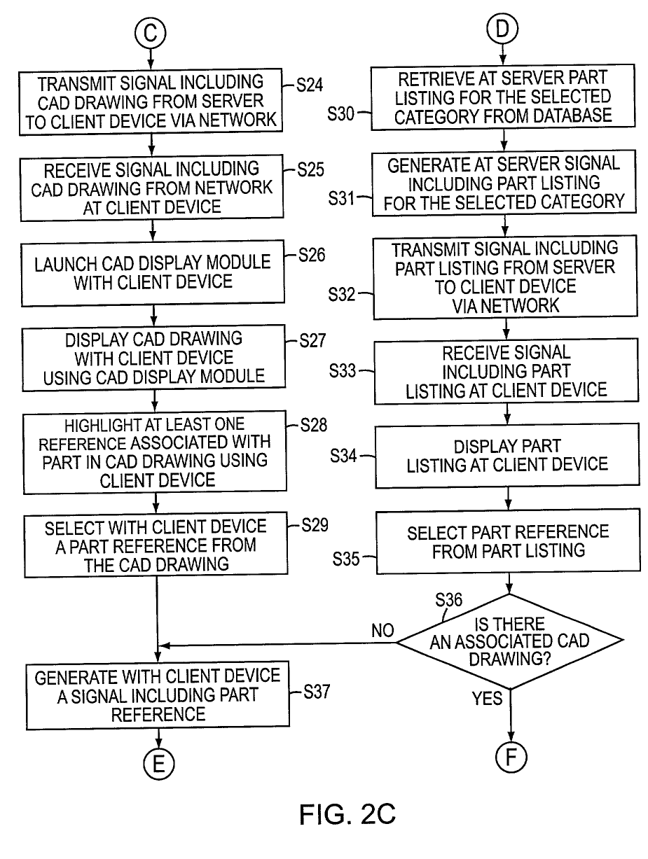

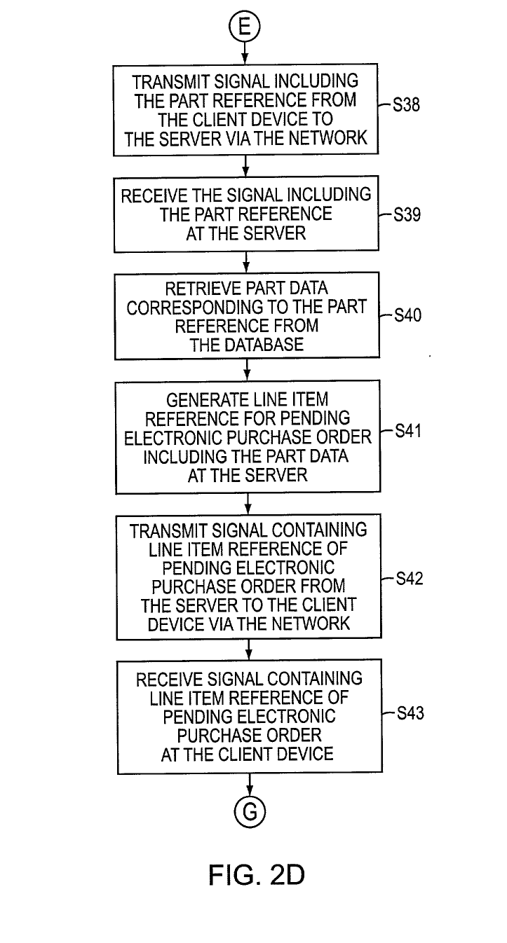

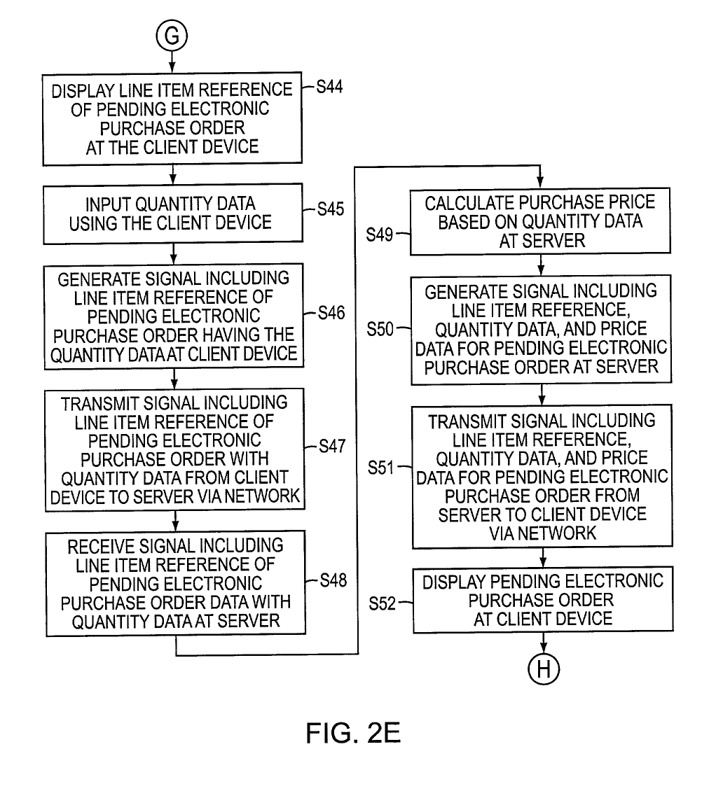

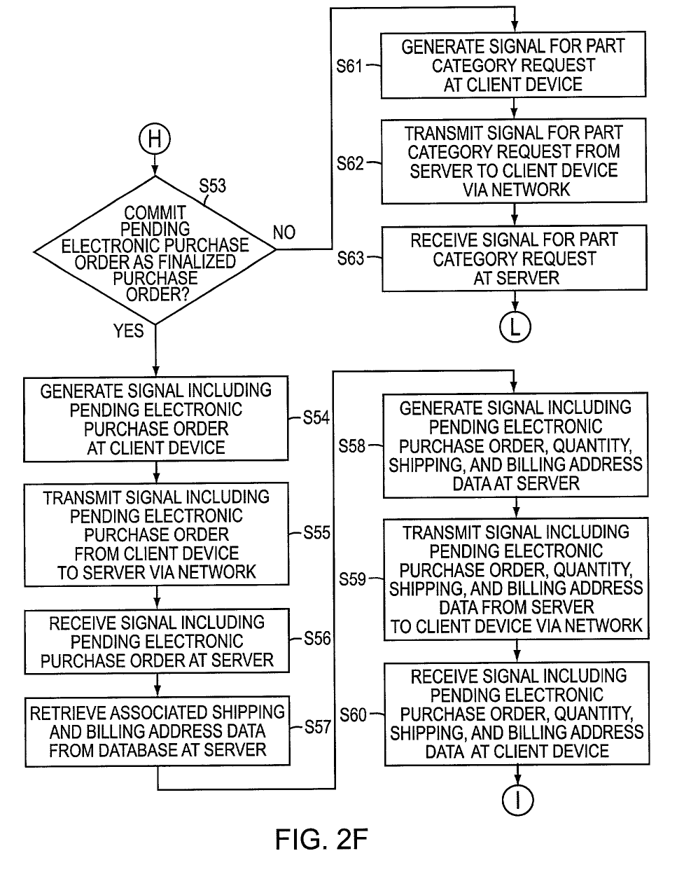

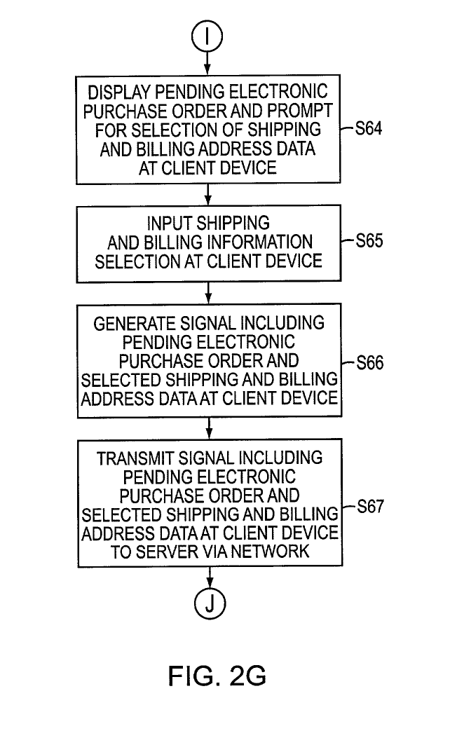

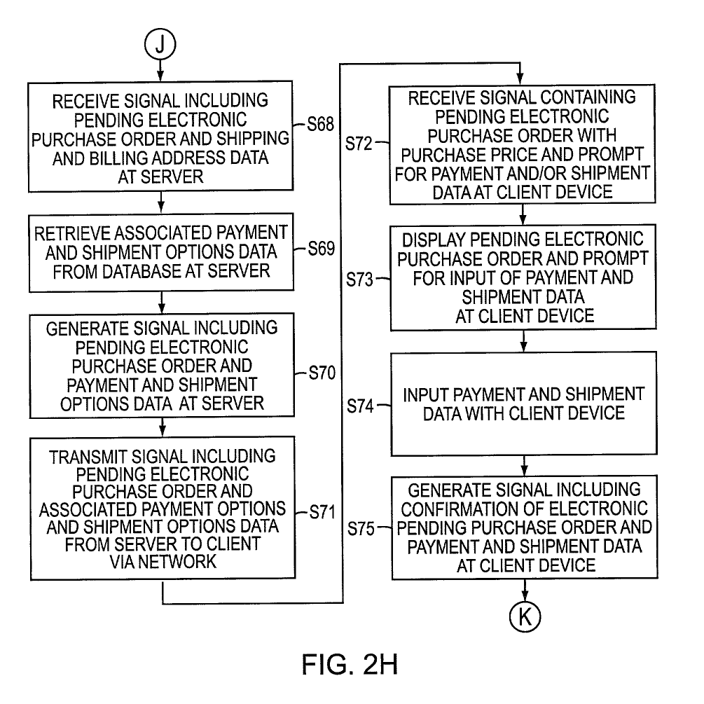

A flow chart of a relatively detailed method of the invention begins in step S 1 of FIG. 2A. In step S2 a user inputs a user name and password into the client device using its input unit. In step S3 the client device generates a signal indicating the user name and password. In step S4 the client device transmits the signal indicating the user name and password to a server via a network. In step S5 the server receives the signal indicating the user name and password. In step S6 the server retrieves a pre-stored password from database storage unit based on user name. In step S7 the server compares passwords received from the client device and retrieved from the database storage unit. In step S8 the server determines whether the passwords match. If not, in step S9 the server generates a signal prompting the user to re-input the password. In step S10 the server transmits the signal prompting the user to re-enter the password to the client device via the network. In step S11 the client device receives the signal prompting the user to re-input the password. In step S12 the client device displays the prompt urging the user to re-input the correct password via the client device. On the other hand, if the determination in step S8 is affirmative, in step S13 the server retrieves the catalogs and part categories from the database. In step S14 the server generates a signal including the catalogs and part categories. In step S15 the server transmits the signal including the catalogs and part categories from the server to the client device via the network. In step S16 the client device receives the signal including the catalogs and part categories.

In step S17 of FIG. 2B the client device displays the catalogs and part categories with a browser of the client device. In step S18 the user selects a part category using the client device. In step S19 the client device generates a signal indicating the selected part category. In step S20 the client device transmits the signal indicating the selected part category from the client device to the server via the network. In step S21 the server determines whether the selected part category points to a CAD drawing. If so, in step S22 the server retrieves a computer-aided design (CAD) drawing for the selected part category from the database. In step S23 the server generates a signal including the CAD drawing for the selected part. In step S24 of FIG. 2C the server transmits a signal including the CAD drawing from the server to the client device via the network. In step S25 the client device receives the signal including the CAD drawing from the network. In step S26 the client device launches the CAD display module with the client device upon detecting that the received signal includes a CAD drawing with a “dwg” format. In step S27 the client device displays a CAD drawing using the CAD display module. In step S28 the user operates the client device so as to highlight at least one reference associated with a part in the CAD drawing using the client device. In step S29 the user operates the client device to select a part having a reference from the CAD drawing displayed on the client device. On the other hand, if the determination in step S21 is negative, in step S30 the server retrieves a part listing for the selected part. In step S31 the server generates a signal including the part listing for the selected part. In step S32 the server transmits the signal including the part listing from the server to the client device. In step S33 the client device receives the part listing. In step S34 the client device generates a display of the part listing. In step S35 the user operates the client device to select a part associated with a reference from the part listing. In step S36 the server determines whether the selected part category points to a CAD drawing. If so, the server executes step S22 of FIG. 2B. After performance of either step S29 or a negative response in step S36, in step S37 the client device generates a signal including the part reference. In step S38 of FIG. 2D the client device transmits the signal including the part reference to the server via the network. In step S39 the server receives the signal including the part reference. In step S40 the server retrieves the part data corresponding to part reference. In step S41 the server generates a line item reference of a pending electronic purchase order including the part data. In step S42 the server transmits the signal containing the line item reference for the pending electronic purchase order from the server to the client device via the network. In step S43 the client device receives the signal containing the pending electronic purchase order. In step S44 of FIG. 2E the client device displays the line item reference for the pending electronic purchase order at the client device. In step S45 the user inputs quantity data indicating the number of parts the user desires to purchase. In step S46 the client device generates a signal including the line item reference of the pending electronic purchase order along with the quantity data. In step S47 the client device transmits the signal including the line item reference of the pending electronic purchase order with quantity data to the server via the network. In step S48 the server receives the signal including the line item reference of the pending electronic purchase order with quantity data. In step S49 the server calculates the purchase price for the line item reference of the pending purchase order based on quantity data received from the user. In step S50 the server generates the pending purchase order including the line item reference and the calculated purchase price. In step S51 the server transmits the signal including the pending purchase order, the line item reference, and the calculated price. In step S52 the client device displays the pending electronic purchase order including the line item reference and the calculated price.

In step S53 of FIG. 2F the user either decides to finalize the pending electronic purchase order or browse for an additional part(s). If the user chooses to browse for an additional part(s), in step S61 the client device generates a signal for user-selected catalog(s) and part category(s). In step S62, the client device transmits a signal indicating catalog(s) and part category(s). In step S62 the server receives the signal including catalog(s) and part category(s) and returns to step S13 in FIG. 2A to return to the part browsing process. If in step S53 of FIG. 2F, the user chooses to finalize the pending electronic purchase order, in step S54 the client device generates a signal including the pending electronic purchase order. In step S55 the client device transmits the pending electronic purchase order to the server. In step S56 the server receives the signal from the client device including the pending electronic order. In step S57 the server retrieves the associated shipping and billing address data from the database. The associated shipping and billing address data can be pre-stored for the user upon establishing the user's profile, user name, and password before performance of the method. In step S58 the server generates a signal including the pending electronic purchase order along with shipping and billing address data. In step S59 the server transmits a signal including the pending electronic purchase order along with shipping and billing address data. In step S60 the client device receives a signal including the pending electronic purchase order along with shipping and billing address data. In step S64 of FIG. 2G the client device displays the pending electronic purchase order along with shipping and billing address data. In step S65 the user inputs billing and/or shipment data via the client device. In step S66 the client device generates a signal indicating pending purchase order and billing and shipment data. In step S67 the client device transmits the signal including the pending purchase order and billing and shipment data from the client device to the server. In step S68 of FIG. 2H the server receives the signal including the pending purchase order and billing and shipment data from the client device. In step S69 the server retrieves the pending purchase order along with payment and/or shipment options in the database. In step S70 the server generates a signal including the pending purchase order along with user-selected payment and/or shipment options. In step S71 the server transmits a signal including the pending purchase order along with payment and/or shipment options. In step S72 the client device receives the signal including the pending purchase order along with payment and/or shipment options. In step S73 the client device displays the pending purchase order along with payment and/or shipment options. In step S74 the user inputs payment and shipment option via the client device. In step S75 the client device generates a signal including confirmation of the pending electronic purchase order and payment and ship options. In step S76 of FIG. 21 the client device transmits a signal including confirmation of the pending electronic purchase order and payment and shipment options. In step S77 the server receives a signal including confirmation of the pending electronic purchase order and payment and shipment options. In step S78 the server stores the pending electronic purchase order and payment and ship options as a finalized purchase order. In step S79 the server generates a signal including the confirmation of the finalized purchase order. In step S80 the server transmits the confirmation signal from the server to the client device via the network. In step S81 the client device receives the confirmation signal. In step S82 the client device displays the confirmation signal. In step S82 the method of FIGS. 2A-21 ends.

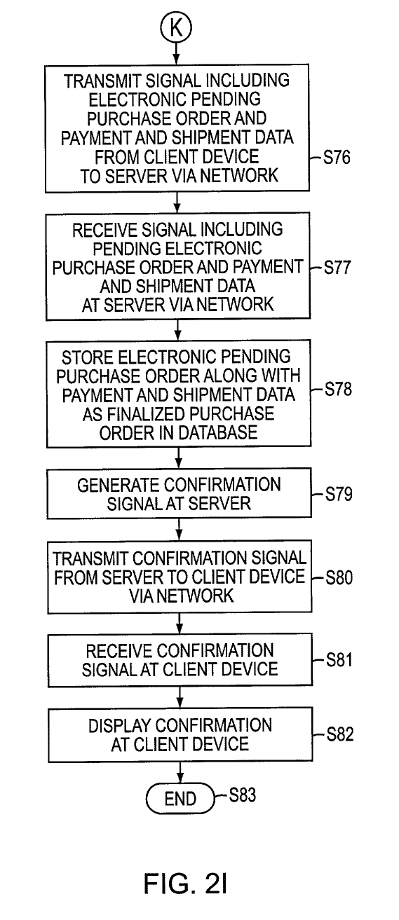

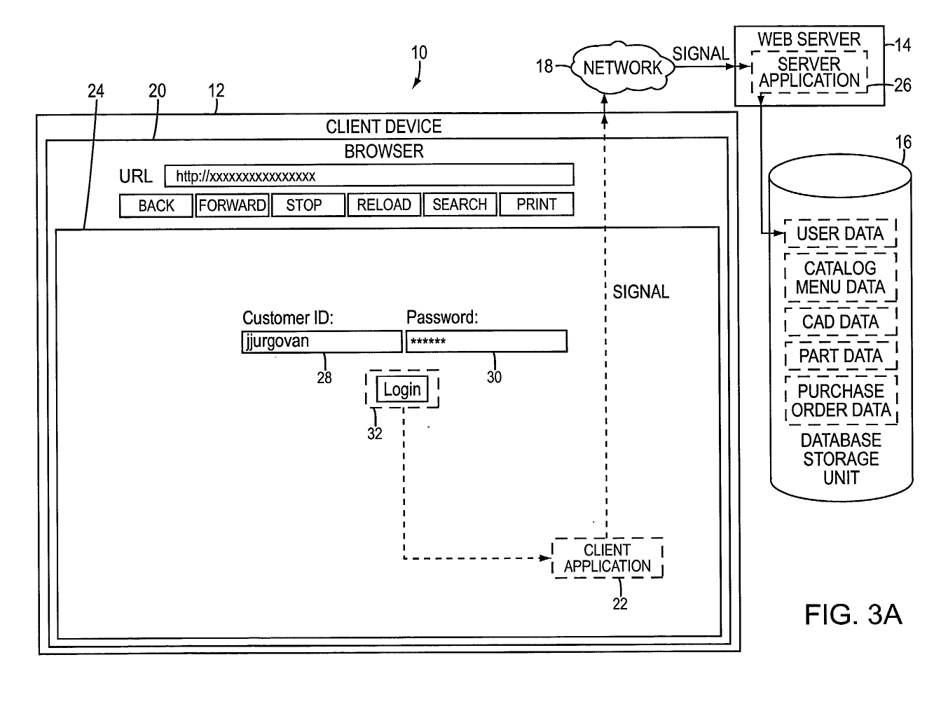

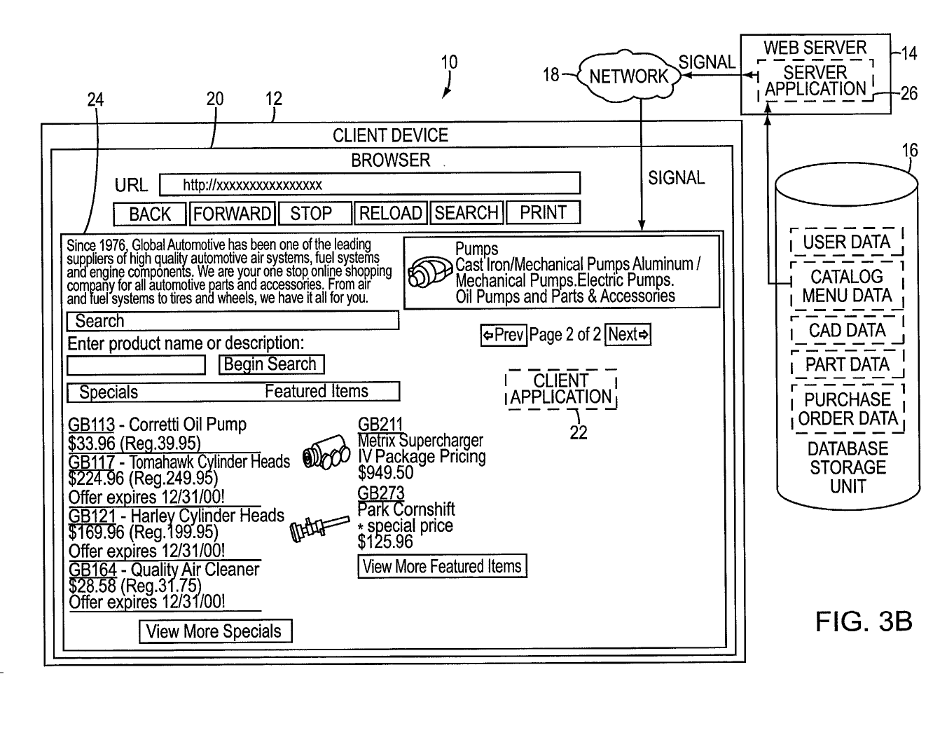

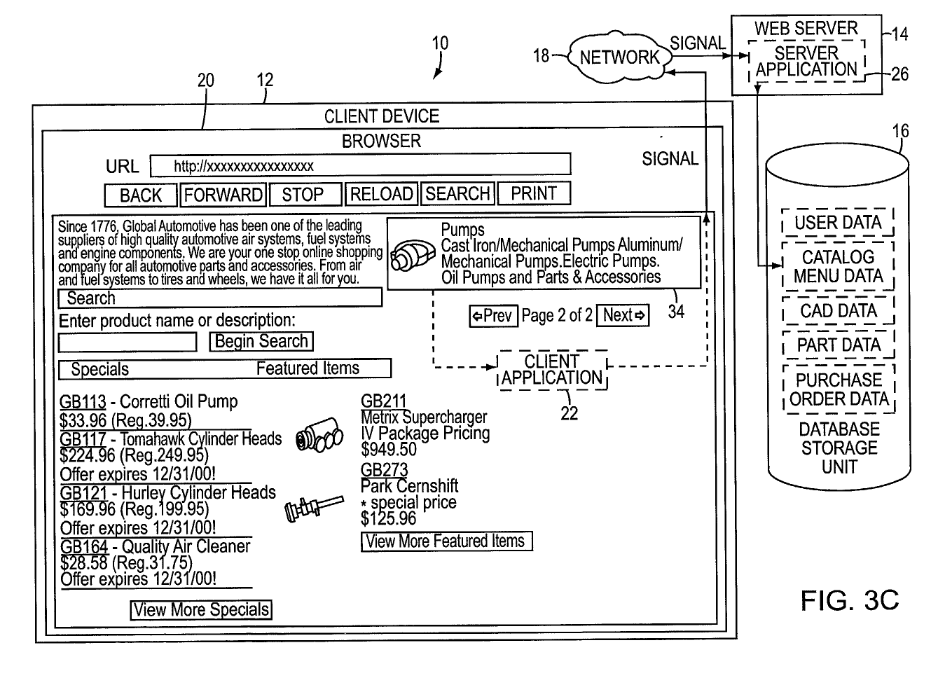

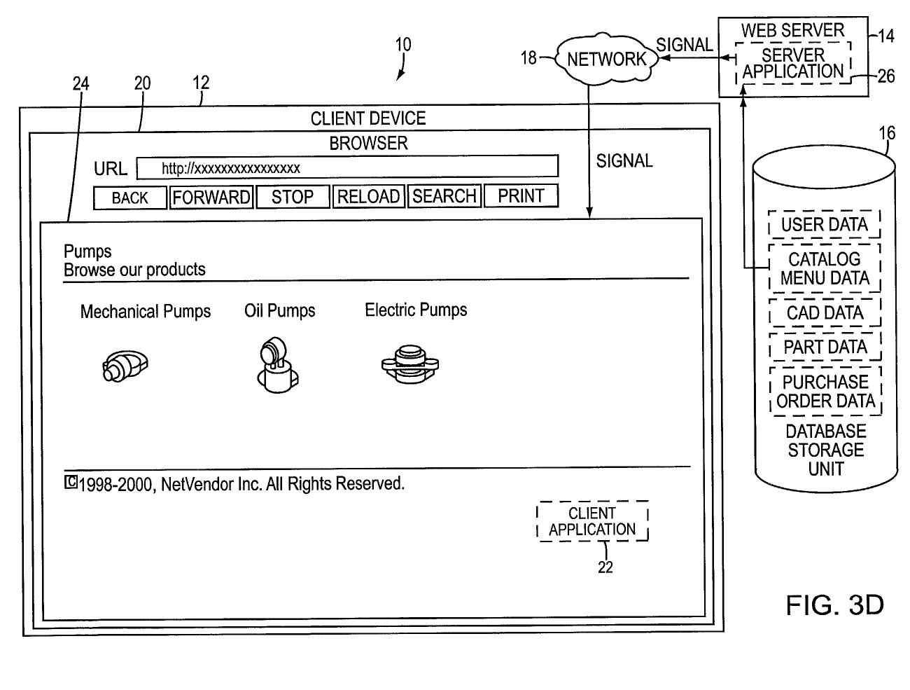

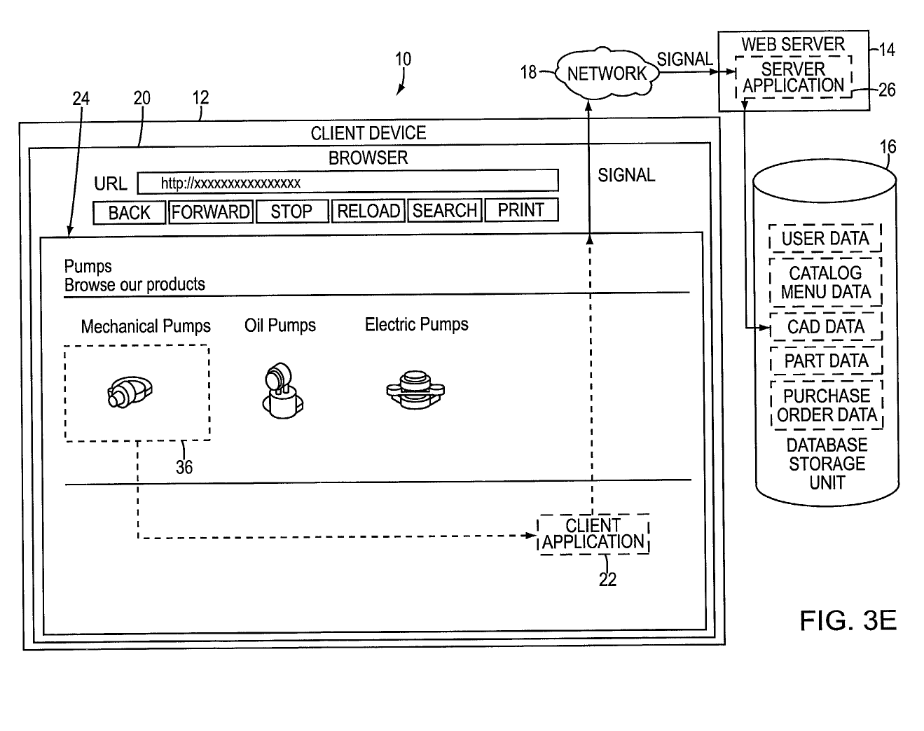

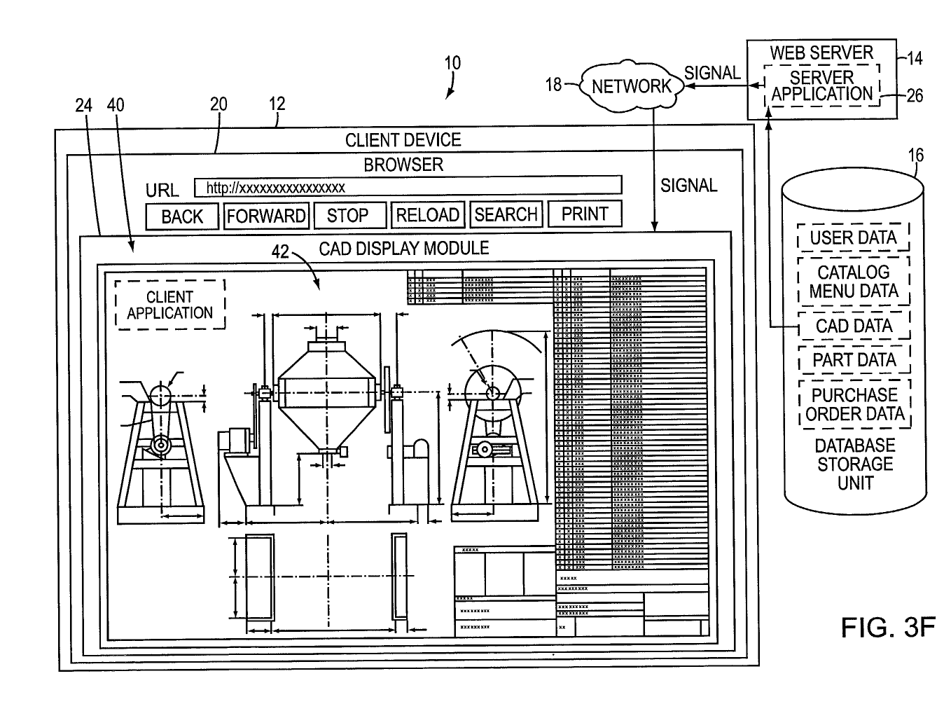

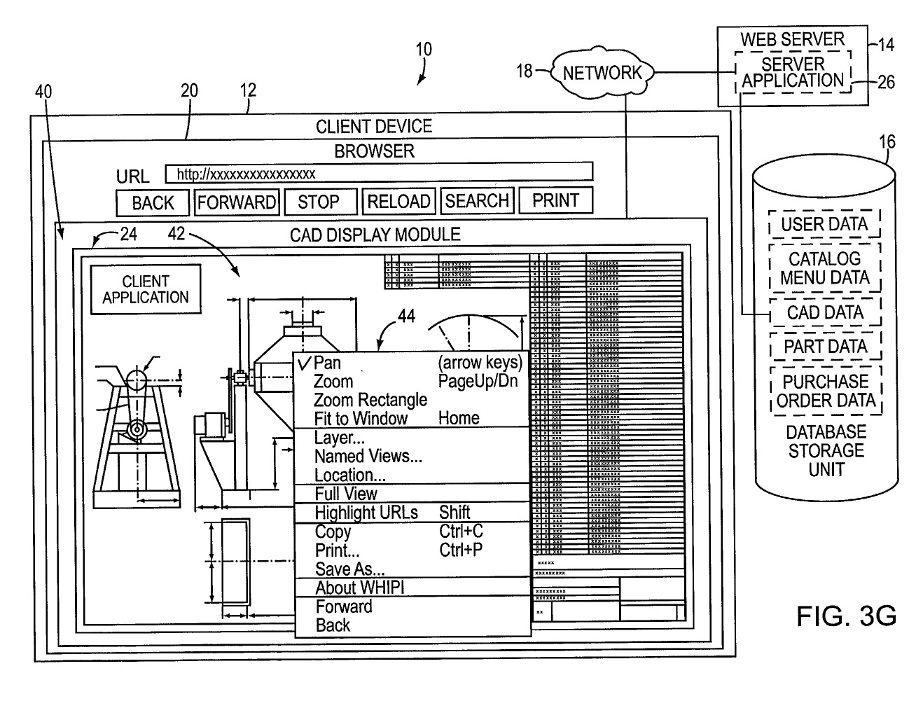

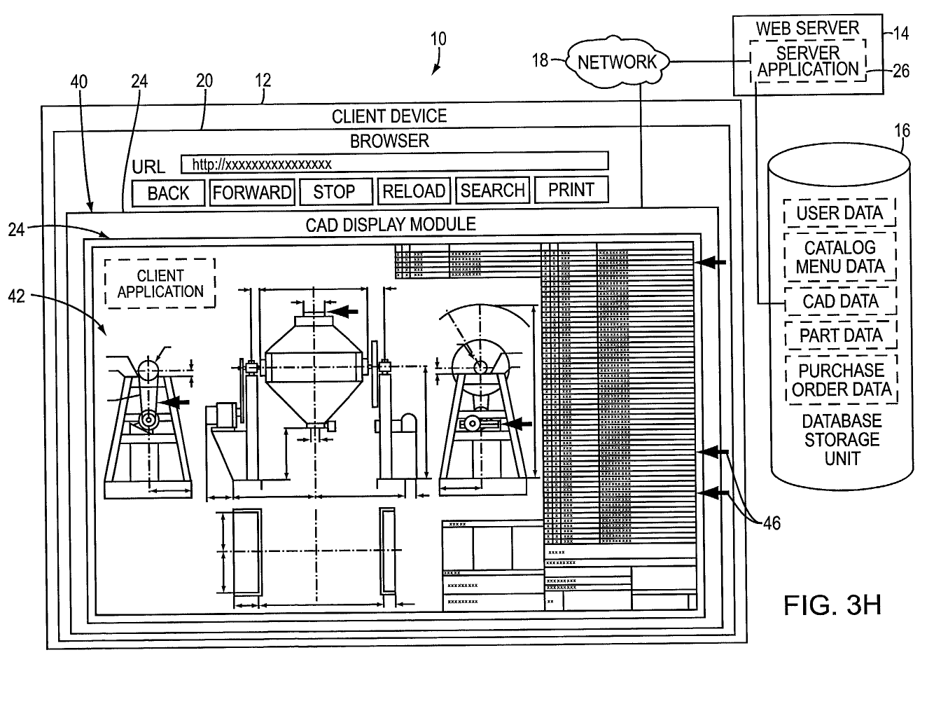

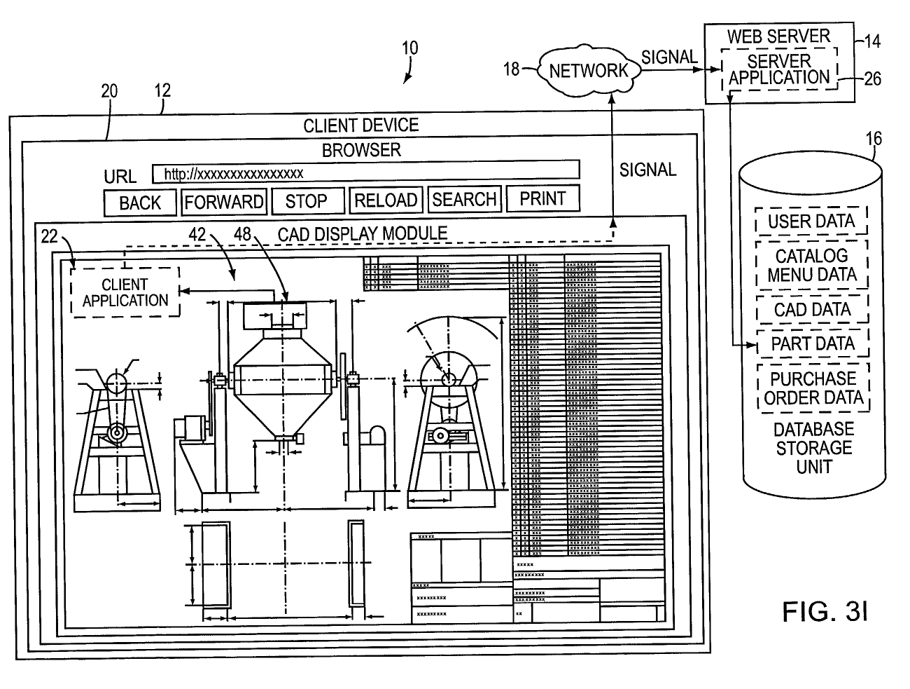

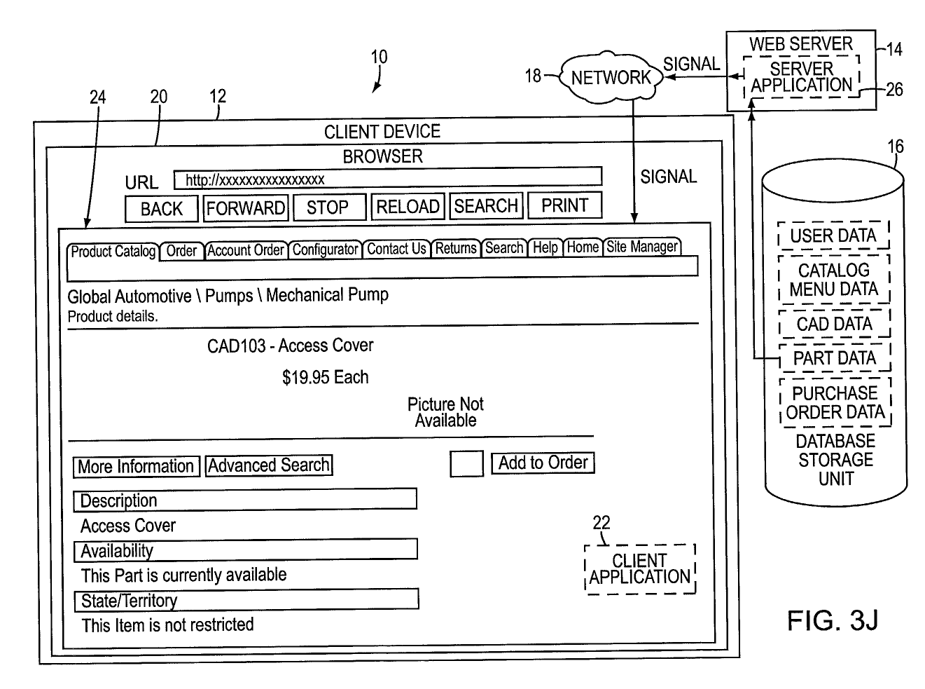

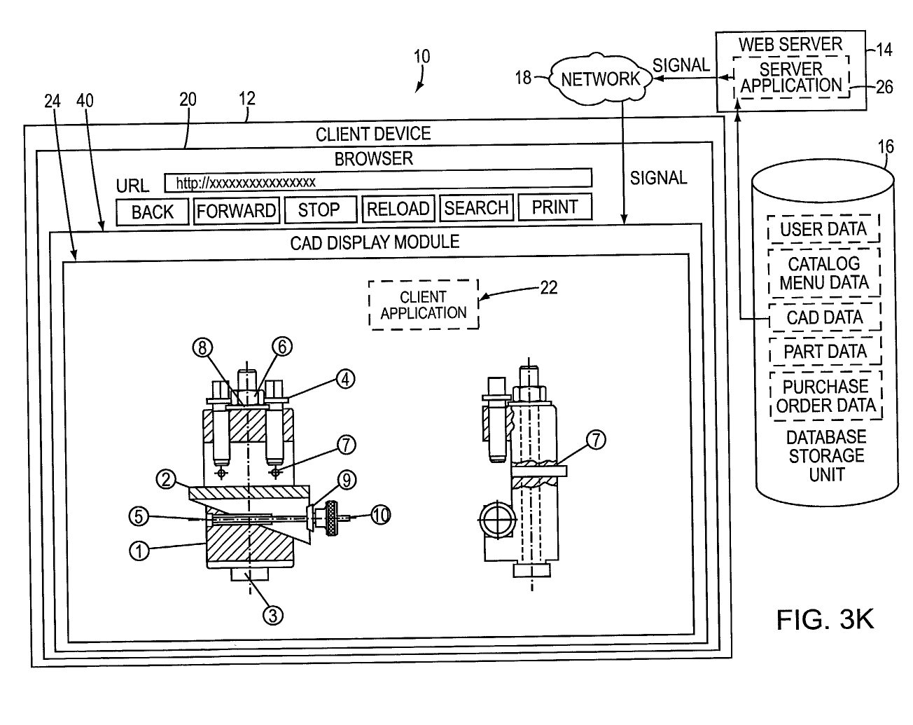

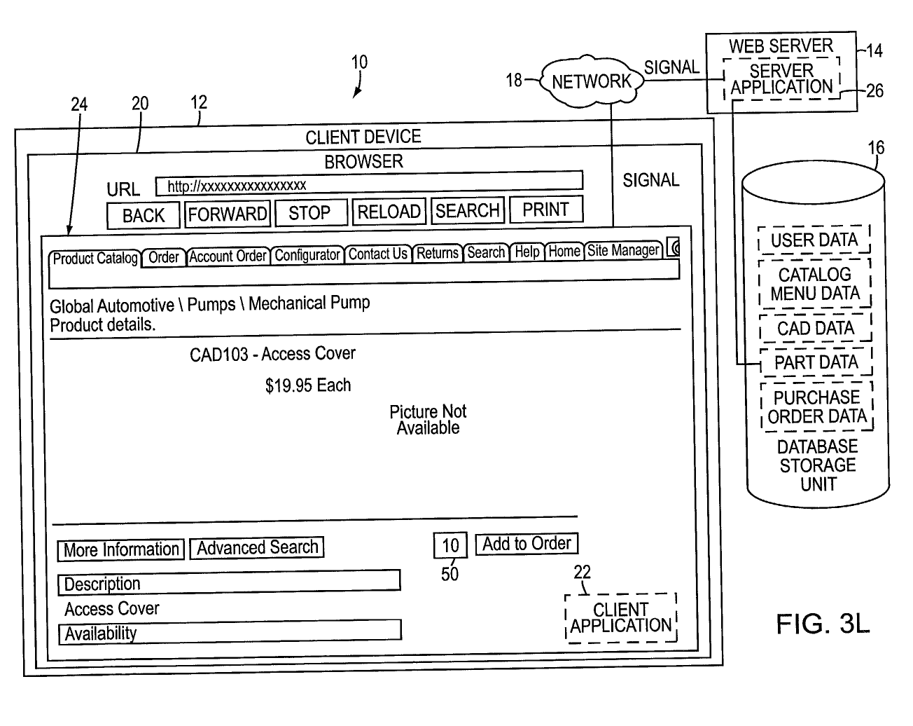

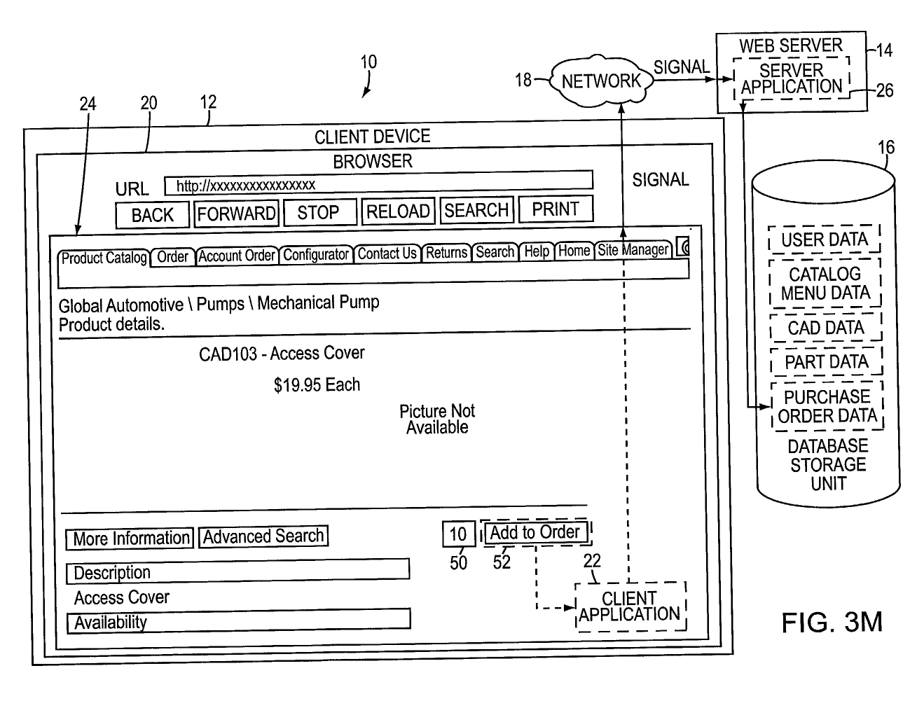

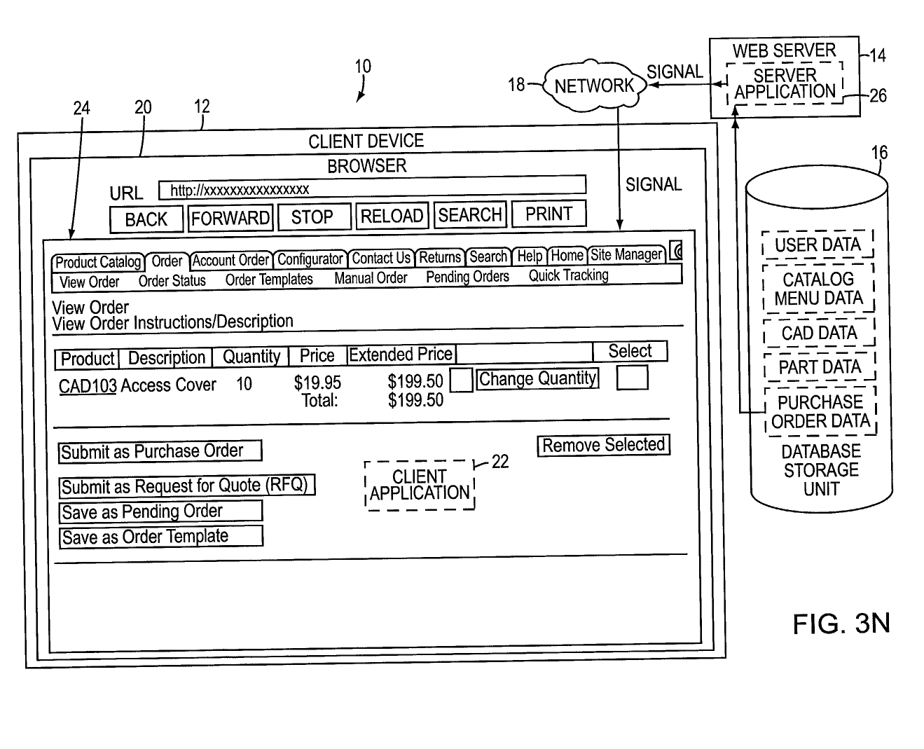

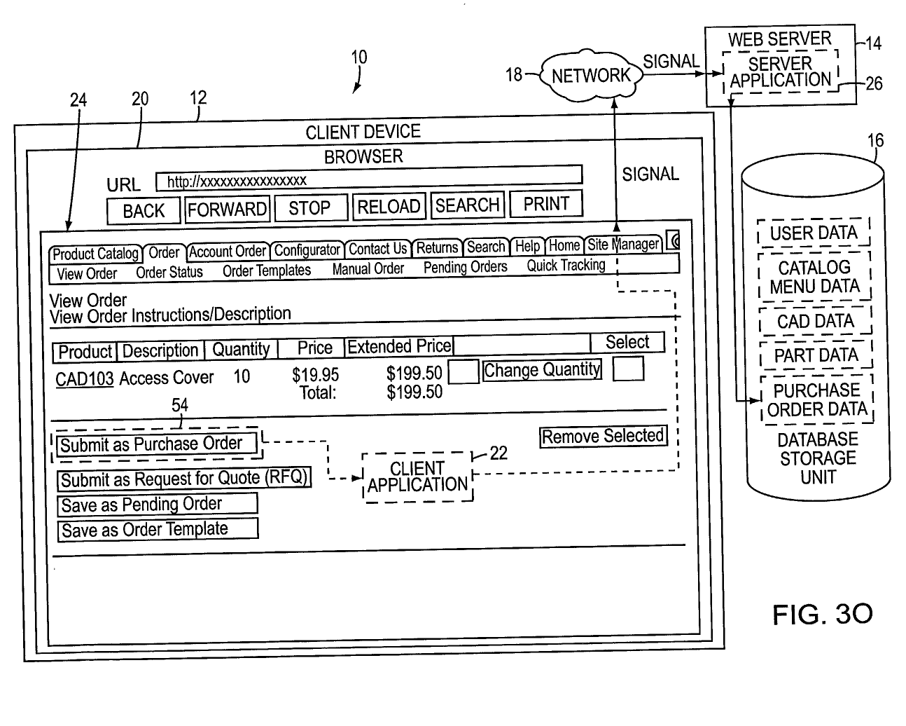

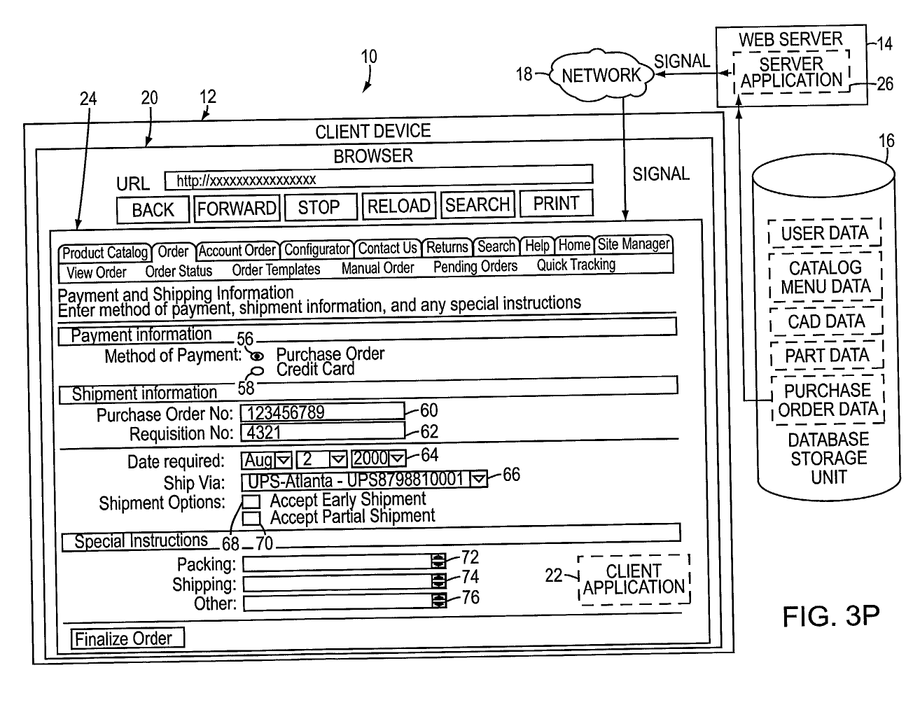

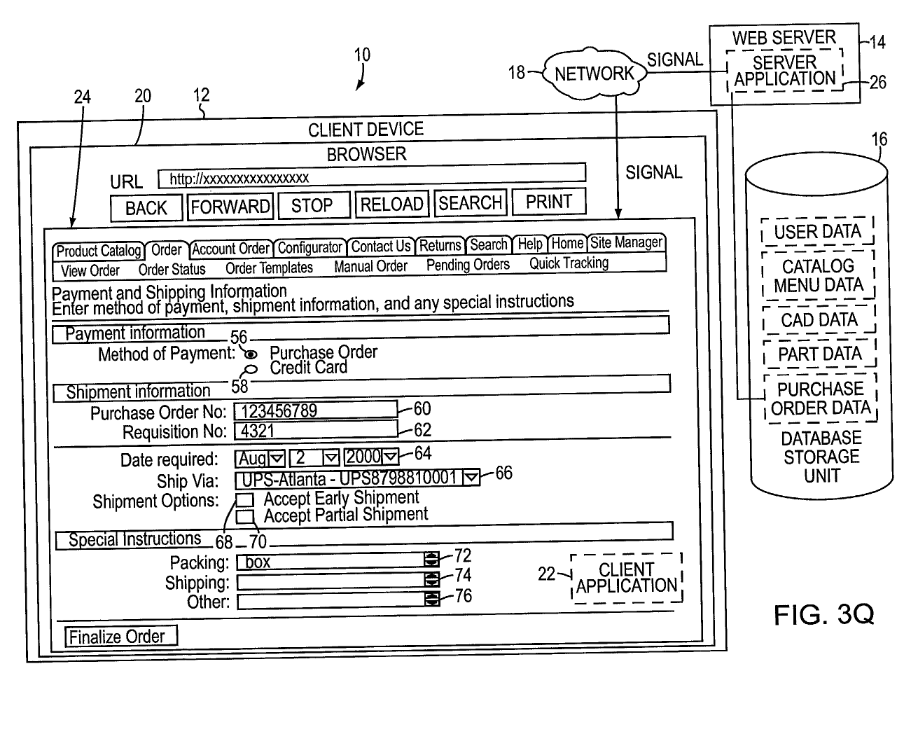

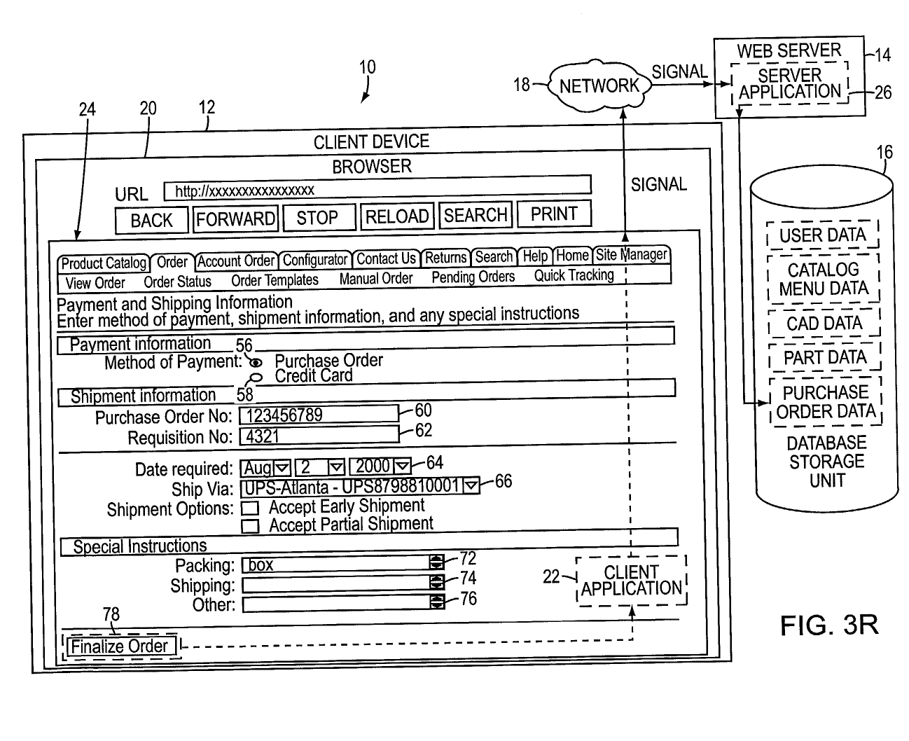

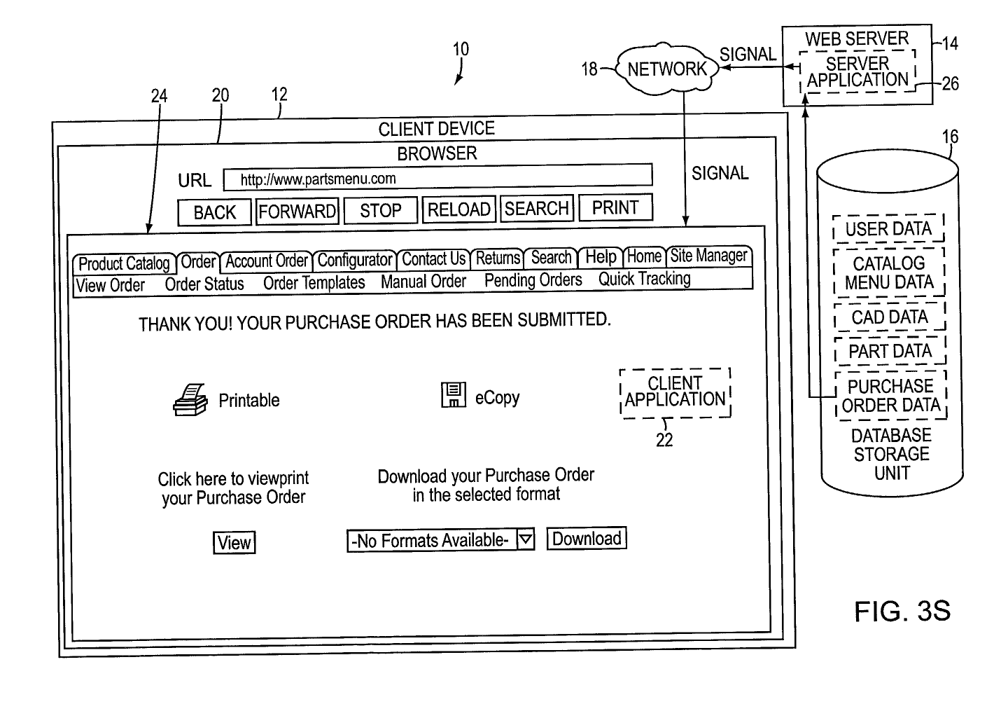

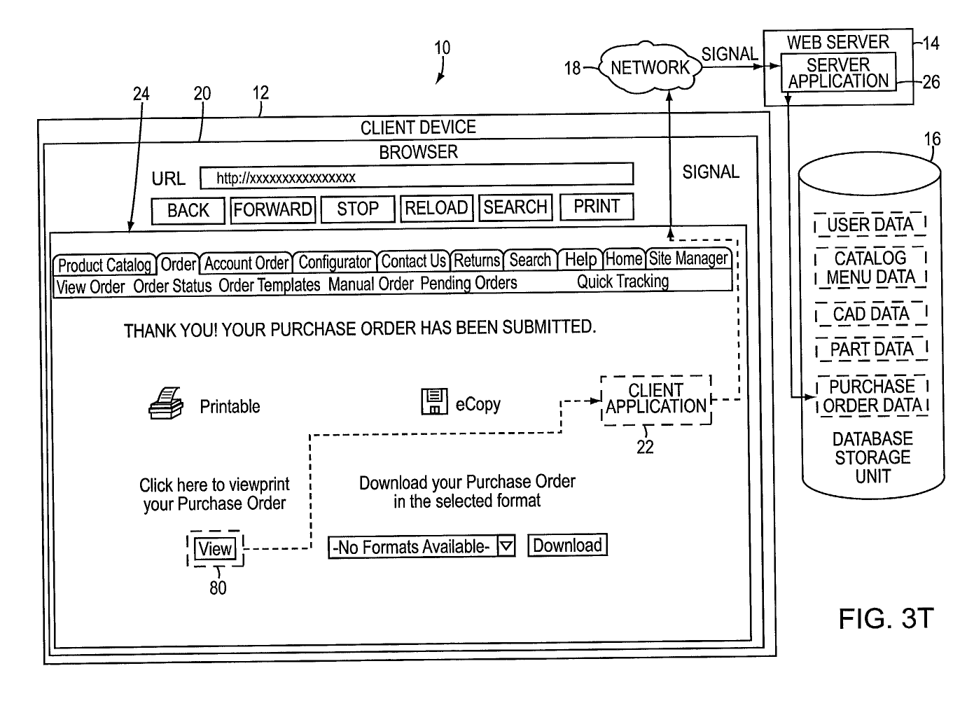

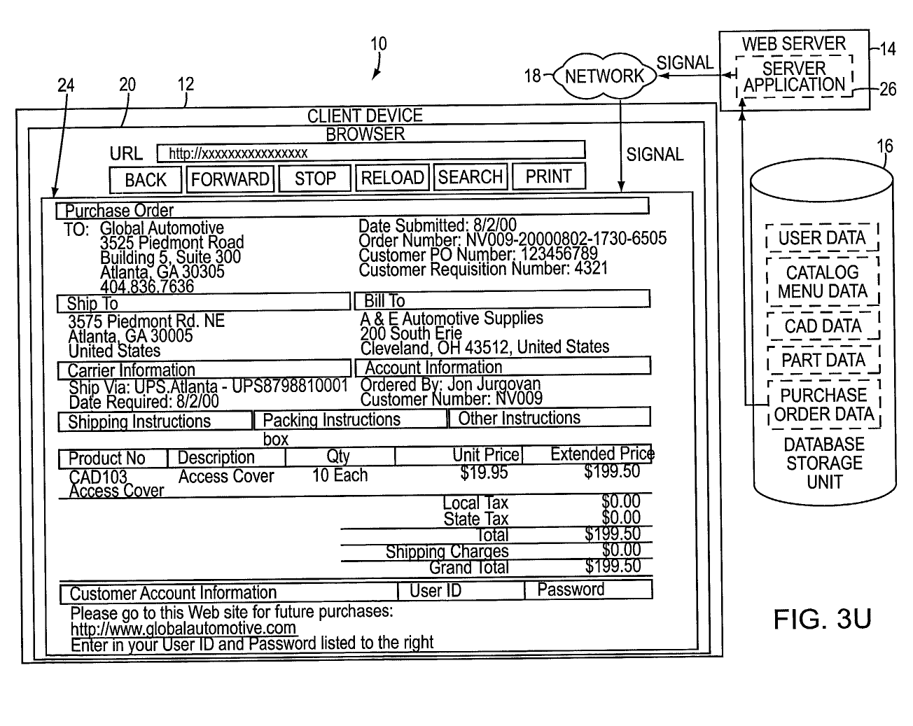

The system and methods of FIGS. 3A-3U are now described. A system 10 of the invention is disclosed in FIGS. 3A-3U. In FIG. 3A the system 10 includes a client device 12, a web server 14, and a database storage unit 16. The client device 12 and the web server 14 can be coupled to the permit communication via network 18. The client device 12 executes a browser application 20 that runs a client application 22. The client application 22 can be included in a web page document executed by the browser application 20. The client application 22 can include scripting language defining the appearance of the display 24, its text, fields, buttons, images, etc. The client application 22 can also includes one or more software modules or applets for performing functions in response to user-driven events such as movement and clicking of the client device's mouse. For example, the client application 22 can include one or more applets coded in HTML or other scripting language document.

The web server 14 executes a server application 26 to perform its functions as described herein. The database storage unit 16 stores various data. Such data can include user data identifying a password of the user, catalog menu documents establishing a hierarchical catalog menu, CAD data files generally in the “dwg” format, and part data that can include part identification data and price data indicating the price of a part. The data stored in the database storage unit 16 can also include purchase order data that is generated by the server in a part purchase transaction, that includes part, quantity, and price data. The server may also store and/or retrieve other data generated by such server in the performance of the methods.

In FIG. 3A the user inputs a customer name in the field 28, in this example “jjurgovan”. The user also inputs the appropriate password in field 30 assigned to such customer by preregistration with the server 14 by methods well known in the art. The user submits the user name and password to the server by clicking with a mouse, for example, on the hyperlink 32 labeled “login”. In response to the clicking of the hyperlink 32 the client application 22 generates a signal indicating the user name and password and transmitted by the client device to the server 14 via the network 18. The server 14 receives this signal, extracts the user name for use in retrieving the password pre-stored as user data in the database storage unit 16. The server 14 compares the entered and pre-stored passwords, and if these passwords do not match, the server will generate and transmit a signal to the client device 14 to notify the user of this fact. The client device 14 receives the signal and generates a display based on such signal to advise the user to re-enter the correct password. On the other hand, if the entered password matches the pre-stored password, the server 14 retrieves a web page document included in the hierarchical part catalog menu from the catalog menu files stored in the database storage unit 16. In FIG. 3B the server 14 generates a signal including the web page document of the hierarchical catalog and part categories retrieved from the database storage unit 16 and transmits the web page document to the client device 12 via the network 18. The client device 12 receives the web page document included within the hierarchical part catalog and part categories and generates a display 24 on the client device 12 as shown in FIG. 3B. In FIG. 3C the user operates the client device 12 to activate the category, i.e., “Pumps” hyperlink 34 of the web page document with an input unit of the client device. This activation event causes the client application 22 of the web page document to generate a signal indicating the next hyperlinked document of the hierarchical catalog and part category to be retrieved via the server 14. The client device 12 transmits this signal to the server 14 via the network 18. The server 14 executes its server application 26 to retrieve the next web page document in the hierarchical catalog and part categories from the database storage unit 16. In FIG. 3D the server 14 generates a signal including the next web page document in the hierarchical catalog and part categories and transmits this document to the client device 12 via the network 18. The client device 12 receives and generates the display of FIG. 3D based on the received document included in the signal. In FIG. 3E the user operates the client device 12 to select a category, i.e., “mechanical pumps” hyperlink 36 from the display 24 generated by the received web page document. The client application 22 detects activation of the “mechanical pumps” category hyperlink and generates a signal indicating the URL of the next file to be retrieved by the server 14. In this example, the hyperlink 36 points to a CAD data file stored in the database storage unit 16. Although not shown in this example, the hyperlink 36 could in general alternatively point to a web page document listing one or more parts that the user can select to hyperlink to a part detail page including part data for the selected part. Returning to the present example in which hyperlink 36 points to a CAD data file, in FIG. 3F, the server 14 retrieves this CAD data file and generates a signal including the CAD data file. The server 14 transmits the signal including the CAD data file to the client device 12 via the network 18. The client device 12 receives the CAD data file and detects that it is in the “dwg” format associated with CAD drawings. The client device 12 therefore launches the CAD display module plug-in 40 to the browser 20. The plug-in module 40 generates the display 24 to include the CAD drawing 42 within the browser 20.

In FIG. 3G the user operates the client device 12 to display pop-up menu 44. The user can accomplish this task by “right clicking” with the mouse, moving the cursor with the mouse so as to overlie the selection “highlight references”, and “left clicking” on this selection. In response to these actions, the CAD display module 40 generates indicators 46 so as to indicate the part(s) within the CAD drawing 42 that have reference(s) associated with them. These indicators 46 may be arrows as shown, flashing highlights, or other display elements to indicate those parts that have references associated with them. In FIG. 3I the user operates the client device 12 to select a part 48 within the drawing that the user may be interested in purchasing. For example, the user can position a cursor over the part and click on the selected part 48 using the mouse or other input unit of the client device. The client device transmits the signal indicating the reference of the selected part to the server 14 via the network 18. The server receives the signal indicating the reference and uses the reference to determine part data associated with the reference in the database storage unit 16. In FIG. 3J the server 14 retrieves part data corresponding to the reference from the database storage unit 16. The server 14 generates a signal including a part detail page with the part data. The part data can identify the part by serial number and/or name, i.e., “CAD103—Access Cover” in this example. The part data also indicates the part price, i.e., “$19.95 Each” in this example. The part data can further include an image of part such as a “gif” or “jpg” image. The server 14 transmits the signal including part detail page with part data to the client device 12 via the network 18 to generate the display 42.

Although in the example of FIG. 3I the reference associated with the part 48 pointed to part data, alternatively, a part selected by a user via a client device 12 can point to another CAD drawing from which additional part selections can be made. Such an example is shown in FIG. 3K. Ultimately, however, through selections of parts in CAD drawings the user will eventually navigate to either a CAD drawing or a part catalog listing with part data.

Returning to consideration of the case in which the part selection results in a display of part data in a part detail web page as shown in FIG. 3J, in FIG. 3L the user inputs quantity data, in this case “10”, in field 50 using the client device 12. In FIG. 3M the user operates the client device 12 to activate the hyperlink 52 labeled “Add to Order” to submit a form including “10” as the quantity data to the server 14. In response to the user's activation of the hyperlink 52 the client application 22 generates a signal indicating the part data and quantity data. The client device 12 transmits the signal including the part data and quantity data to the server 14 via the network 18. The server 14 receives the part data and quantity data and stores this data in the database storage unit 16 as pending purchase order data. In FIG. 3N the server 14 generates a line item reference of a pending electronic purchase order for the user-selected part, based on the part data and quantity data. The server 14 generates a signal including the line item reference for the part in the pending electronic purchase order and transmits this signal to the client device 12 via the network 18. The client device 12 receives the signal including the line item reference for the part in the pending electronic purchase order from the server 14 and generates the display 24 including the part identification data including “CAD103” and “Access Cover”, quantity data “10”, and price data “$19.95”. The user can review the line item reference of the pending electronic purchase order data at the client device 12. If the purchase order is not as intended by the user, the user can operate the “back” button of the browser application 20 to back through the series of web pages to correct an error in the line item reference of the electronic purchase order. Alternatively, the user can select the tab “Product Catalog” to return to the display of FIG. 3B to enter a line item reference for an additional part the user may elect to purchase. On the other hand, if the user is satisfied with the pending purchase order, the user can activate the hyperlink 54 labeled “Submit as Purchase Order.” In response to activation of the hyperlink 54 the client application 22 generates a signal including the pending purchase order for the part(s), as shown in FIG. 30. The client device 12 transmits the signal including the pending electronic purchase order from the client device 12 to the server 14 via the network 18. The server 14 receives the signal containing the pending purchase order and stores this as purchase order data in the database storage unit 16. In FIG. 3P the server 14 retrieves a form document from the purchase order data to prompt the user to input payment mode, shipment data, and/or packaging instructions. The server 14 can populate one or more of the fields of the form document with payment mode, shipment, and/or packaging data defined in connection with the user's pre-stored profile by retrieval of such data from the database storage unit 16. The server 14 generates a signal including the form document to prompt the user to enter payment mode data, shipment data, and/or packaging instructions. The server 14 transmits this signal to the client device 12 via the network 18. In FIG. 3P the client device 12 receives the signal prompting the user to input payment mode, shipment data, and/or packaging instructions. The client device 12 generates the display 24 to include the prompts for entry of the payment mode data, shipment data, and/or packaging instructions. As shown in FIG. 3P for payment mode the user can input either “purchase order” meaning the purchaser will be billed, or can select “credit card” meaning the user will pay for the part with a credit card. The user can enter data to indicate the customer's purchase order number and requisition number in fields 60, 62, respectively. In field 64 the user can enter the date by which the part is needed by the recipient. In field 66 the user can select a particular carrier to use for shipment of the part. In fields 68, 70 the user can select various shipment options including “Accept early shipment” and “Accept Partial Shipment.” In fields 72, 74, 76, respectively, the user can input packing instructions for the part, shipping information for the part, or other information pertaining to handling of the part. In FIG. 3Q the user inputs payment mode data, shipment data, and packing data as desired. In FIG. 3R the user activates the software button 78 to submit the payment mode data, shipment data, and packing data to the server 14. In response to activation of the software button 78 the client application 22 generates signal including the payment mode data, shipment data, and packing data. The client device 12 transmits the signal including the payment mode data, shipment data, and packing data from the client device 12 to the server 14 via the network 18. The server 14 receives the signal including the payment mode data, shipment data, and packing data and stores this data as purchase order data in the database storage unit 16. In FIG. 3S the server 14 retrieves a web page document from the database storage unit 16 to prompt the user to select whether to receive the finalized electronic purchase order including payment mode, shipment, and packing data in printable hard copy or electronic softcopy. In FIG. 3T the user selects the software button 80 labeled “View”. In response to activation of the software button 80 the client application 22 generates a signal indicating that a printed copy of the purchase order has been requested by the user. The client device 12 transmits the signal requesting the printed copy of the purchase order to the server 14 via the network 18. The server receives the signal indicating the request for the printed copy. In response to the signal the server 14 executing its application 26 retrieves purchase order data from the database storage unit 16. In FIG. 3U the server 14 retrieves the finalized purchase order data from the database storage unit 16. The server 14 generates a signal including the finalized purchase order data and transmits this signal to the client device 12 via the network 18. The client device receives and displays the finalized purchase order for printing by the user as shown in FIG. 3U. The user can log out of the session with the server 14.

Although beyond the scope of this invention, the server 14 can be programmed to provide access to electronic purchase order data via the network 18 to another party(s). Such party(s) could include a part supplier(s) for acceptance and fulfillment of the user's purchase order, a financial institution(s) such as a bank for transfer of finds between buyer(s) and seller(s) of the part(s) associated with the purchase order using the billing data. Such party(s) could also include packager(s) and/or carrier(s) for packaging and shipping the part to the shipping address, for example.

### 4. Detailed Example of Reference to Part Data or CAD Drawing Embedded in Association with the Part Depicted in the CAD Drawing

The server application 26 can be coded so as to be used to transact purchase of a part whether the user selects a part by activation of a part in a CAD drawing with the client device 12, or selects the part through a part catalog listing with the client device 12. A reference used to associate the part shown in a CAD drawing to the part data or another CAD drawing stored in the database storage unit can be embedded in the CAD drawing using standard features of AutoCAD® 20001 software commercially-available from AutoDesk, Inc. The HTTP protocol can be used to pass the reference and part data or CAD drawing between the client device 12 and the server 14. An exemplary HTTP protocol reference to the purchase transaction processing code of the server application 26 could be: http://demo.netvendor.com/autodemo40b/Item/ASP/Item-Detail.asp?PartNo=CAD100 &CatalogGroupld=CG6B&GroupDisplayLabel=Mechanical+Pumps

The URL shown above can be embedded in the CAD drawing. The format of the request is: http://SERVER NAME/SERVER DIRECTORY/ItemDetail.asp?PartNo=NETVENDOR EMBRACE PART ID&CatalogGroupld=NETVE NDOR

EMBRACE_CATALOG_GROUP_ID&GroupDisplayLabel=NETVENDOR_EMBRACE_CATALOG_GROUP_LABEL_TEXT in which:

SERVER_DIRECTORY is the virtual directory on the web server 14 where the server application 26 is installed.

Item-Detail.asp is the code that displays data about a part so that it can be ordered. PartNo is the part number of the item that is stored in the server application 26. CatalogGroupId is the software catalog or sub catalog group Identifier that is associated with the part.

GroupDisplayLabel is the name of the catalog or sub catalog group that is associated with the part.

In the situation in which the user's selection of a part in the CAD drawing via the client device 12 leads to display of another CAD drawing, a URL is embedded in the CAD drawing and is sent via HTTP to the web server 14 where the purchase transaction processing code of server application 28 receives and processes the HTTP request. An explicit example of such a reference is as follows: http://demo.netvendor.com/autodemo40b/Catalog/ASP/AutoCAD.asp?CatalogGroupId=CG6B&GroupDisplayLabel=Mechanical+Pumps&AutoCADPicture= . . . / . . /Images/Product s/toolpost.dwf

The HTTP request format has the following form: http://SERVER_NAME/SERVER_DIRECTORY/AutoCAD.asp?CatalogGroupld=NET VENDOR_EMBRACE_CATALOG_GROUP_ID&GroupDisplayLabel=NETVENDOR_{—}EMBRACE_CATALOG_GROUP_LABEL_TEXT&AutoCADPicture=NETVENDO R_EMBRACE_RELATIVE_PATH_OF_AUTOCAD_DRAWING

All fields are the same except that in this case PartNo is not used but AutoCADPicture is used. AutoCADPicture is the relative path of the AutoCAD drawing in relation to the E.MBRACE web directory structure.

### 5. Data Structures

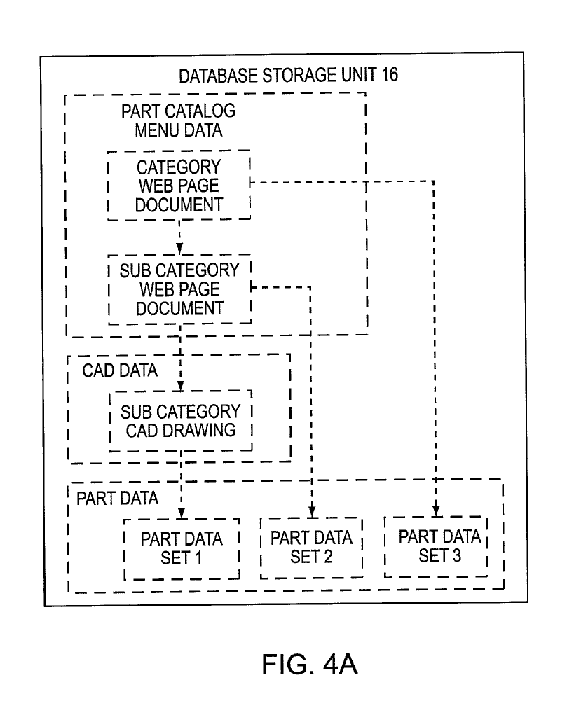

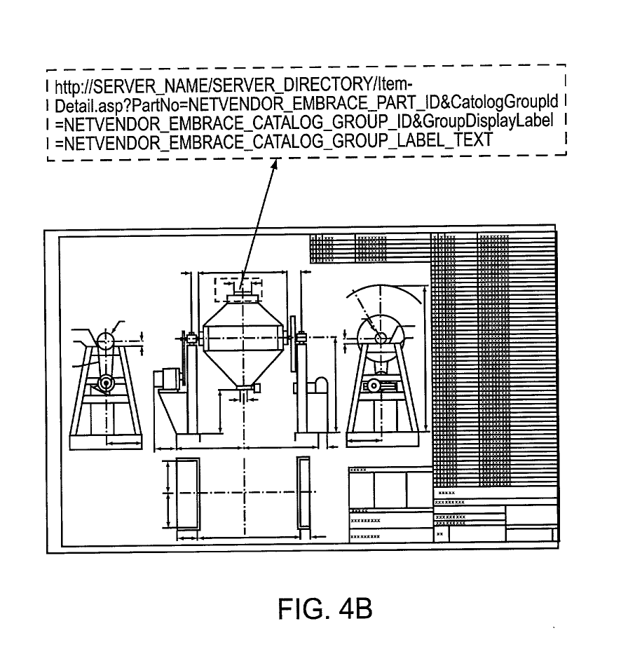

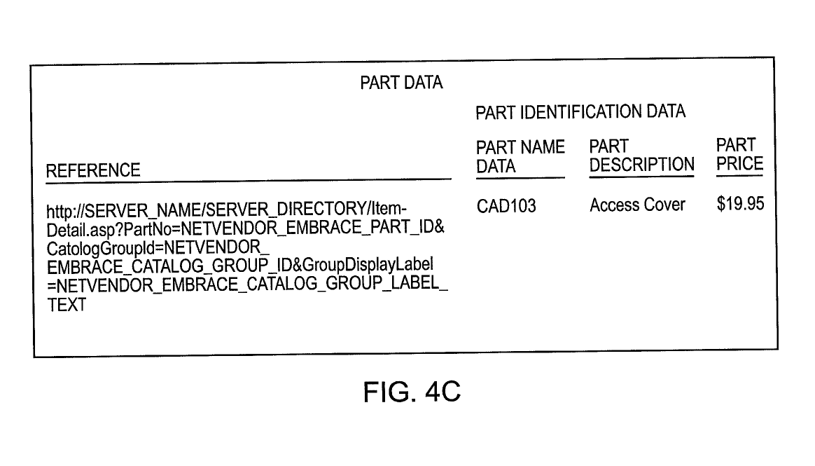

FIGS. 4A-4C are relatively detailed views of data structures pertaining to the hierarchical catalog menu files, CAD data files, and the part data stored in the database storage unit 16. In this exemplary data structure, referring to FIG. 4A, the catalog menu data includes category (e.g., see the GUI display of FIG. 3B) and sub category (e.g., see the GUI display of FIG. 3D) web page documents hyperlinked as indicated by the arrows in FIG. 4A. The sub category is hyperlinked to a sub category CAD data file (e.g., see the GUI display of FIG. 3F) that is in turn hyperlinked via the reference to the part data set #1. The sub category web page document may as well be linked via reference to part data such as part data set #2 so that the user can select a part from a the sub category web page document without use of a CAD drawing to select the part. This provides flexibility to permit the user to select parts either from part listings in sub category web page documents as well as from CAD drawings. Part data may also be linked by reference directly to a category web page document without intermediate sub category(s) documents, as is the case with part data set #3.

In FIG. 4B the part of the CAD drawing file and its associated reference: http://SERVER NAME/SERVER DIRECTORY/Item-Detail.asp?PartNo=NETVENDOR_EMBRACE_PART_ID&CatalogGroupId=NETVE NDOR_EMBRACE_CATALOG_GROUP_ID&GroupDisplayLabel=NETVENDOR_EMBRACE_CATALOG_GROUP_LABEL_TEXT are indicated. In FIG. 4C the part data includes the reference listed in correspondence with part identification data, part description data, and part price data.

### 6. Computer program in Computer-Readable or Signal Transmission Media

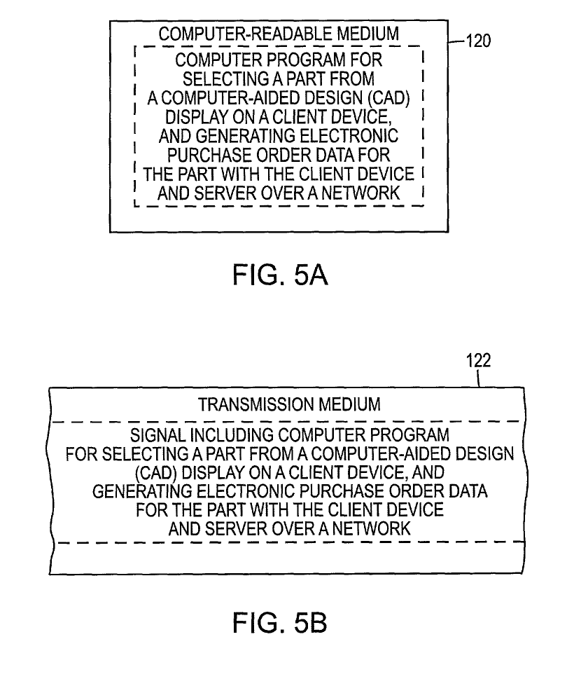

As shown in FIG. 5A the invention extends to a medium readable by a client device, server, or other computing device. The computer-readable medium includes a computer program for selecting a part from a computer-aided design (CAD) display on a client device, and transacting purchase of the part with the client device and server over a network.

### 7. Alternative and Modifications to Disclosed Embodiments

Although particular embodiments have been disclosed to facilitate understanding of the invention, it should be understood that numerous modifications and alternative implementations of the invention are possible without departing from the scope of the invention. For example, in FIG. 4A more than one sub catalog CAD data file can be hyperlinked together, the last in the hyperlinked series being linked to the part data. This permits a user to navigate from a relatively general CAD drawing of a part assembly to a CAD drawing of a part within that assembly to purchase a part of interest. In addition, although the invented methods, system, and HTML web page documents and HTTP protocol are discussed herein, it is expressly contemplated that other protocols such as XML and other technologies could be used to support interaction between client device and server(s). In addition although only one client device is shown in the drawings, it should be clear that a plurality of client devices could be used. All of these modifications are intended to be included within the scope of the invention.

The many features and advantages of the present invention are apparent from the detailed specification and thus, it is intended by the appended claims to cover all such features and advantages of the described system, methods, database structure, computer-readable medium, and transmission medium which follow in the true spirit and scope of the invention. Further, since numerous modifications and changes will readily occur to those of ordinary skill in the art, it is not desired to limit the invention to the exact construction and operation illustrated and described. Accordingly, all suitable modifications and equivalents may be resorted to as falling within the spirit and scope of the invention.

1. A method comprising the steps of:
a) selecting a part from a computer-aided design (CAD) display on a client device; and
b) generating electronic purchase order for the selected part with a server through interaction of the client device and server over a network, based on the selecting of step (a).

2. A method as claimed in claim 1 further comprising the step of:
c) generating the CAD display with a browser running a CAD display plug-in module on the client device.

3. A method as claimed in claim 1 wherein the selecting of the step (a) is performed with an input unit of the client device.

4. A method as claimed in claim 1 wherein the electronic purchase order includes at least part identification data and price data for the selected part.

5. A method as claimed in claim 1 wherein the electronic purchase order includes at least part identification data, quantity data, and price data.

6. A method as claimed in claim 1 further comprising the steps of:
c) navigating through a part catalog of category(s) and sub category(s) of web page documents through interaction of the client device and server;
d) retrieving CAD data resulting from the navigating of the step (c) from a database storage unit with the server;
f) generating a signal including the CAD data with the server;
g) transmitting the signal with the CAD data from the server to the client device via the network;
h) receiving the signal with the CAD data at the client device; and
i) generating the CAD display at the client device, based on the CAD data.

7. A method as claimed in claim 6 further comprising the steps of:
j) generating a signal indicating the selected part with the client device in response to the selecting of the step (a);
k) transmitting the signal indicating the selected part with the client device to a server via a network;
l) receiving the signal indicating the selected part at the server; and
m) retrieving part data from a database storage unit using the signal indicating the selected part, the server generating the electronic purchase order in the step (b) based on the retrieved part data.

8. A method as claimed in claim 6 wherein the signal includes a reference linked to the selected part in the CAD display, and the server uses the reference to retrieve part data linked to the reference from the database storage unit in the step (j).

9. A method as claimed in claim 8 wherein the reference is a universal resource locator (URL).

10. A method as claimed in claim 8 further comprising the steps of:
g) generating with the server a signal indicating part detail based on the part data;
h) transmitting the signal indicating the part detail with the server to the client device via the network;
i) receiving the signal indicating part detail at the client device; and
j) displaying the part detail with the client device.

11. A method as claimed in claim 10 further comprising the step of:
k) determining whether to add the part reference to the electronic purchase order;
if the determination in step (k) is affirmative,
l) generating with the client device a signal indicating that the part reference is to be added to the electronic purchase order;
m) transmitting the signal indicating that the part reference is to be added to the electronic purchase order from the client device to the server;
n) receiving the electronic purchase order at the server; and
o) storing the part reference with the server as a line item of the electronic purchase order.

12. A method as claimed in claim 11 further comprising the steps of:
if the determination in the step (k) is negative,
p) determining whether to add another part reference to the electronic purchase order, and
if the determination in step (p) is affirmative,
q) repeating step (c) and following steps.

13. A method as claimed in claim 12 further comprising the steps of:
if the determination in the step (p) is negative,
r) determining whether the electronic purchase order is to be committed as a finalized purchase order; and
if the determination in the step (r) is affirmative,
s) inputting payment data via client device;
t) inputting shipment data via client device;
u) generating a signal indicating payment data and shipment data with the client device;
v) transmitting the signal indicating the payment data and the shipment data with the client device to the server via the network; and
w) receiving the signal indicating the payment data and shipment data with the server, the server using the payment data and shipment data to generate the electronic purchase order in step (b).

14. A method as claimed in claim 13 further comprising the steps of:
before the inputting of the step (s),
x) retrieving payment mode data, shipment address data, and/or packaging instruction data pre-stored in the database storage unit in association with a profile of the user of the client device;
y) populating the electronic purchase order with the retrieved payment mode data, shipment data, and/or packaging instruction data;
z) generating a signal including the electronic purchase order populated with the retrieved payment mode data, shipment data, and/or packaging instruction data with the server;
a′) transmitting the signal populated with the retrieved payment mode data, shipment data, and/or packaging instruction data with the server to the client device via the network; and
b′) receiving the signal populated with the retrieved payment mode data, shipment data, and/or packaging instruction data at the client device; and
c′) generating a display of the electronic purchase order populated with the retrieved payment mode data, shipment data, and/or packaging instruction data at the client device.

15. A method as claimed in claim 13 further comprising the steps of:
x) inputting quantity data at the client device;
y) generating a signal including the quantity data at the client device;
z) transmitting the signal including the quantity data from the client device to the server via the network;
a′) receiving the signal including the quantity data at the server;
b′) calculating price data based on the part data and quantity data at the server; and
c′) storing the price data as purchase order data for the electronic purchase order in the database storage unit with the server.

16. A method as claimed in claim 1 further comprising the steps of:
c) generating at the server a signal including a prompt to input at least one of payment mode data, address data, and packaging data;
d) transmitting the signal including the prompt from the server to the client device via the network;
e) receiving the signal including the prompt at the client device; and
f) displaying the prompt at the client device.
g) inputting at least one of payment mode data, address data, and packaging data at the client device;
h) generating a signal including at least one of the payment mode data, the address data, and the packaging data, at the client device;
i) transmitting the signal from the client device to the server via the network; and
j) storing at least one of the payment mode data, address data, and packaging data as purchase order data for the electronic purchase order in the database storage unit.

17. A method as claimed in claim 1 further comprising the step of:
c) navigating through a hierarchical part catalog menu; and
d) generating the CAD display as a result of the navigating of the step (c).

18. A method as claimed in claim 17 wherein the navigating includes substeps of:
c1) generating a CAD display of a sub category including the part;
c2) selecting the part from the sub category in the CAD display; and
c3) generating a CAD display of the part used for the selecting of the step (a).

19. A method as claimed in claim 17 wherein the hierarchical catalog menu includes a tree of web pages having a first web page with a category, the first web page hyperlinked to a second web page with a sub category, the second web page hyperlinked to a third web page having a sub category. the third web page hyperlinked to a fourth web page having the part data.

20. A method as claimed in claim 1 wherein the selected part is an automobile part.

21. A method comprising the steps of:
a) displaying a computer-aided design (CAD) drawing with a browser of a client device;
b) selecting a part in the CAD drawing with an input device of the client device;
c) generating a signal indicating the selected part with the client device in response to the selecting of the step (b);
d) transmitting the signal indicating the selected part from the client device to the server via the network;
e) receiving the signal indicating the selected part at the server via the network; and
f) generating an electronic purchase order for purchase of the part, based on the selected part indicated by the received signal.

22. A method as claimed in claim 21 wherein the step (a) is performed with a CAD display module plug-in to the browser.

23. A method as claimed in claim 21 further comprising the steps of:
after the step (a) but before the step (b),
g) highlighting at least one part in the CAD drawing having a reference, and wherein the step (b) of selecting includes the substep of clicking upon the highlighted reference with a mouse of the client device to select the part.

24. A method as claimed in claim 21 further comprising the steps of:
g) transmitting the electronic purchase order from the server to the client device;
h) receiving the electronic purchase order at the client device; and
i) displaying the electronic purchase order at the client device.

25. A method as claimed in claim 24 further comprising the steps of:
j) inputting purchase data into the electronic purchase order at the client device;
k) generating a message including the electronic purchase order with purchase data at the client device;
l) transmitting the electronic purchase order with purchase data from the client device to the server;
m) receiving the electronic purchase order with purchase data at the server; and
n) storing the electronic purchase order with purchase data at the server.

26. A method comprising the steps of:
a) creating a hierarchy of part category(s) and sub category(s) in respective part catalog(s);
b) storing the hierarchy of part category(s) and sub category(s) in a database storage unit;
c) associating part reference(s) with part category(s), sub category(s), and catalog(s);
d) associating reference(s) with respective part computer-aided design (CAD) data;
e) linking CAD data to associated part catalog(s), category(s), sub category(s) reference(s), and associated part reference(s); and
f) storing reference(s) to respective CAD data in the database storage unit.

27. A method comprising the steps of:
a) retrieving with a server a computer-aided design (CAD) drawing having at least one part with a respective reference from a database storage unit;
b) transmitting the CAD drawing with the part from the server to a client device;
c) receiving a signal including a reference to a selected part from the client device;
d) retrieving part data corresponding to the selected part from the database storage unit, based on the reference; and
e) generating an electronic purchase order based on the part data.

28. A method as claimed in claim 27 further comprising the steps of:
f) receiving the CAD drawing at the client device;
g) generating a display of the CAD drawing at the client device;
h) selecting a part from the CAD drawing with the client device; and
i) generating the signal including the reference to the selected part.

29. A method comprising the steps of:
a) associating at least one reference with a respective part of a computer-aided design (CAD) drawing;
b) storing the CAD drawing in a database storage unit; and
c) storing part data in association with the reference in the database storage unit.

30. A system operable by a user via a network, the system comprising:
a client device coupled to the network;
a server coupled to the network; and
a database storage unit coupled to the server,
the client device having a computer-aided design (CAD) display module plug-in to a browser running on the client device, the client device generating a CAD display having at least one part, the client device operable by the user to generate a signal indicating a user-selected part in the CAD display, the client device transmitting the signal indicating the user-selected part to the network; and
the server coupled to receive the signal indicating the user-selected part from the client device via the network, the server retrieving part data from the database storage unit based on the signal indicating the user-selected part, the server generating an electronic purchase order for the part based on the part data retrieved from the database storage unit.

31. A system as claimed in claim 30 wherein the signal indicating the user-selected part includes a reference associated with the part in the CAD display, and wherein the server uses the reference to retrieve part data stored in the database storage unit in association with the reference in the database storage unit.

32. A system as claimed in claim 31 wherein the reference is a universal resource locator (URL).

33. A system as claimed in claim 30 wherein the electronic purchase order includes at least part identification data and price data included in the part data.

34. A system as claimed in claim 30 wherein the server transmits the electronic purchase order to the client device via the network, and the client device displays the electronic purchase order to the user.

35. A system as claimed in claim 30 wherein the user inputs quantity data at the client device, the client device generates a signal indicating the quantity data, and the client device transmits the signal from the client device to the server via the network, the server receiving and storing the quantity data as purchase order data in the database storage unit.

36. A system as claimed in claim 30 wherein the server calculates price data based on the part data and quantity data stored as purchase data in the database storage unit.

37. A system as claimed in claim 30 wherein the server generates a signal including a prompt to input at least one of payment mode data, address data, and packaging data, and transmits the signal including the prompt from the server to the client device via the network, the client device receiving the signal including the prompt at the client device, and displaying the prompt at the client device.

38. A system as claimed in claim 30 wherein the user inputs at least one of payment mode data, address data, and packaging data at the client device, the client device generates a signal including at least one of the payment mode data, the address data, and the packaging data, the client device transmitting the signal including the from the a at the client device, the client device transmitting the signal to the server via the network, the server storing the at least one of the payment mode data, address data, and packaging data as purchase order data in the database storage unit.

39. A system as claimed in claim 30 wherein the server generates a signal including a prompt to copy purchase order data, the server transmits the signal with copy prompt from server to client device, the client device receives the signal with copy prompt from the server, and the client device generates a display of the copy prompt at the client device.

40. A system as claimed in claim 30 wherein the server generates the copy prompt signal to indicate different modes for copying the purchase order data, and the client device receives and generates the display to include the prompt for the different modes for copying the purchase order data, the user selecting one of the modes for copying the purchase order using the client device, the client device generating a signal indicative of the mode for copying the purchase order and transmitting the signal indicating the mode of copying the purchase order from the client device to the server, the server receiving the signal indicating the mode of copying the purchase order at the server, the server retrieving the purchase order data from the database storage unit, and the server transmitting the purchase order data to a device coupled to the network selected based on the selected mode of copying the purchase order.

41. A system as claimed in claim 30 wherein the user operates the client device to navigate through a hierarchical part catalog menu defined by hyperlinking of web page documents transferred by the server, the client device generating the CAD display of the part as a result of the navigation through linked web page documents.

42. A system as claimed in claim 41 wherein the client device interacts with the server under control of the user to generate a CAD display of a sub category including the part, the user selects the part from the sub category in the CAD display, and the client device generates the CAD display of the part for selection by the user.

43. A system as claimed in claim 42 wherein web page documents served by the server and stored in the database storage unit define a hierarchical part catalog menu including a tree a category web page hyperlinked to one or more sub category web pages with references to part data stored in association with the references.

44. A system as claimed in claim 30 wherein the selected part is an automobile part.

45. A system as claimed in claim 30 wherein the selected part is a truck part.

46. A system as claimed in claim 30 wherein the selected part is an aircraft part.

47. A system as claimed in claim 30 wherein the selected part is a boat part.

48. A system as claimed in claim 30 wherein the selected part is a machine part.

49. A method as claimed in claim 30 wherein the electronic purchase order includes part identification data, quantity data, and price data.

50. A method as claimed in claim 30 wherein the electronic purchase order includes at least one of payment mode data, shipment address data, and packing instruction data.

51. A database storage unit storing at least one computer-aided design (CAD) data file for generating a display of a part having a reference, and part data including part identification data and part price data stored in association with the reference.

52. A database storage unit as claimed in claim 51 wherein the reference is a universal resource locator.

53. A computer-readable medium including a computer program for selecting a part from a computer-aided design (CAD) display on a client device, and generating an electronic purchase order for the part with the client device and a server over a network.

54. A transmission medium for carrying a signal including a computer program for selecting a part from a computer-aided design (CAD) display on a client device, and for generating an electronic purchase order for the part with the client device and a server over a network.

55. A data structure comprising a computer-aided design (CAD) drawing depicting a part with at least one reference, and part data stored in association with the reference.

56. A data structure as claimed in claim 55 wherein the reference includes a universal resource locator (URL).

57. A data structure as claimed in claim 55 wherein the part data includes part identification data and part price data.
